(19) United States
(12) Patent Application Publication
(10) Pub. No.: US 2025/0083792 A1
(43) Pub. Date: Mar. 13, 2025

(54) CIRCUMFERENTIAL SKIN JOINTS FOR AEROSPACE STRUCTURES, METHODS OF ASSEMBLING THE JOINTS, AND METHODS OF MANUFACTURING FUSELAGE MEMBERS THAT DEFINE THE JOINTS

(71) Applicant: The Boeing Company, Arlington, VA (US)

(72) Inventors: Danilo Vukosav, Kirkland, WA (US); Mark R. McLaughlin, Snohomish, WA (US); Ronald L. McGhee, Lynnwood, WA (US); Christopher B. Barney, Everett, WA (US); Gary M. Buckus, Snohomish, WA (US); Max U. Kismarton, Renton, WA (US)

(21) Appl. No.: 18/462,934

(22) Filed: Sep. 7, 2023

(51) Int. Cl. B64C 1/06; B64C 1/12; B64F 5/10

(52) U.S. Cl. CPC B64C 1/069; B64C 1/12; B64F 5/10

(57) ABSTRACT

A circumferential skin joint according to the present disclosure may comprise a first composite fuselage member having a first composite skin comprising a first chamfer at least partially defining a first distal end of the first composite fuselage member, the first chamfer defining a first tapered mating surface extending circumferentially around an outer surface of the first composite fuselage member. In some examples, the circumferential skin joint further comprises a second composite fuselage member having a second composite skin, the second composite skin comprising a second chamfer at least partially defining a second distal end of the second composite fuselage member and defining a second tapered mating surface extending circumferentially around an inner surface of the second composite fuselage member. The first tapered mating surface contacts the second tapered mating surface to form a tapered lap joint between the first composite fuselage member and the second composite fuselage member.

### FIELD

The present disclosure relates generally to circumferential skin joints for aerospace structures, to methods of assembling the joints, and/or to methods of manufacturing fuselage members that define the joints.

### BACKGROUND

Skin joints in aerospace structures, such as aircraft, rockets, satellites, and/or the like, generally comprise assemblies of joined skin components. Conventional joined skin components are butt joints, in which two discrete joined skin components are coupled to a common splice strap. Obtaining a tight fit between adjacent joined skin components requires numerous fasteners and components, which increase cost, manufacturing time, and weight of the aerospace structure. Furthermore, butt joints require shimming to properly manage gaps between the joined skin components.

Complicating joint design within aerospace structures is that joined skin components often comprise cylindrical, semi-cylindrical, or other components having a radius of curvature, such as barrels, half, barrels, and/or the like. Accordingly, it is beneficial for joints utilized in aerospace structures to be suitable for joining components in circumferential joints.

### SUMMARY

Circumferential skin joints for fuselages of aerospace structures and related methods are disclosed. A circumferential skin joint according to the present disclosure comprises a first composite fuselage member having a first composite skin and a second composite fuselage member having a second composite skin. The first composite skin comprises a first chamfer that at least partially defines a first distal end of the first composite fuselage member. The first chamfer defines a first tapered mating surface that extends circumferentially around an outer surface of the first composite fuselage member. The second composite skin comprises a second chamfer that at least partially defines a second distal end of the second composite fuselage member. The second chamfer defines a second tapered mating surface that extends circumferentially around an inner surface of the second composite fuselage member. The first tapered mating surface contacts the second tapered mating surface to form a tapered lap joint between the first composite fuselage member and the second composite fuselage member and to at least partially define a composite fuselage of an aerospace structure.

A method of assembly of a circumferential skin joint according to the present disclosure includes: sliding a first tapered mating surface of a first composite fuselage member having a first composite skin against a second tapered mating surface of a second composite fuselage member having a second composite skin. In some examples, the first composite skin comprises a first chamfer that at least partially defines a first distal end of the first composite fuselage member. The second composite skin comprises a second chamfer that at least partially defines a second distal end of the second composite fuselage member. The method of assembly of a circumferential skin joint according to the present disclosure further includes: fastening the first chamfer to the second chamfer to define the circumferential skin joint between the first composite fuselage member and the second composite fuselage member and to at least partially define a composite fuselage of an aerospace structure. The first chamfer defines a first tapered mating surface that extends circumferentially around an outer surface of the first composite fuselage member. The second chamfer defines a second tapered mating surface that extends circumferentially around an inner surface of the second composite fuselage member. The sliding the first composite fuselage member against the second composite fuselage member includes sliding the first tapered mating surface against the second tapered mating surface such that the first chamfer is interior to the second chamfer.

A method of manufacturing a first composite fuselage member includes: selecting a slope of a first tapered mating surface of the first composite fuselage member, forming a first laminate defining an overall shape of a first composite skin of the first composite fuselage member, and forming the first tapered mating surface within the first laminate. The first composite skin comprises a first chamfer that at least partially defines a first distal end of the first composite fuselage member. The first chamfer defines the first tapered mating surface, such that the first tapered mating surface extends circumferentially around an outer surface of the first composite fuselage member. The first tapered mating surface of the first composite fuselage member is configured to be coupled to a complementary second tapered mating surface of a second composite fuselage member to form a circumferential skin joint of a composite fuselage of an aerospace structure.

### BRIEF DESCRIPTION OF THE DRAWINGS

FIG. 1 is a schematic cross-sectional diagram representing examples of a first illustrative circumferential tapered lap joint in accordance with the present teachings.

FIG. 2 is a schematic orthogonal view of an aircraft including circumferential tapered lap joints, according to the present disclosure.

FIG. 3 is an exploded view of the aircraft of FIG. 2.

FIG. 4 is a schematic cross-sectional diagram representing examples of a second illustrative circumferential tapered lap joint in accordance with the present teachings.

FIG. 5 is a schematic cross-sectional diagram representing examples of a third illustrative circumferential tapered lap joint in accordance with the present teachings.

FIG. 6 is a schematic cross-sectional diagram representing examples of a fourth illustrative circumferential tapered lap joint in accordance with the present teachings.

FIG. 7 is a schematic cross-sectional diagram representing examples of a fifth illustrative circumferential tapered lap joint in accordance with the present teachings.

FIG. 8 is a flowchart schematically representing examples of methods of assembling circumferential tapered lap joints in accordance with the present teachings.

FIG. 9 is a flowchart schematically representing methods of manufacturing fuselage members suitable for use in circumferential tapered lap joints in accordance with the present teachings.

### DESCRIPTION

Circumferential skin joints and related methods are disclosed. Generally, in the figures, elements that are likely to be included in a given example are illustrated in solid lines, while elements that are optional to a given example are illustrated in broken lines. However, elements that are illustrated in solid lines are not essential to all examples of the present disclosure, and an element shown in solid lines may be omitted from a particular example without departing from the scope of the present disclosure.

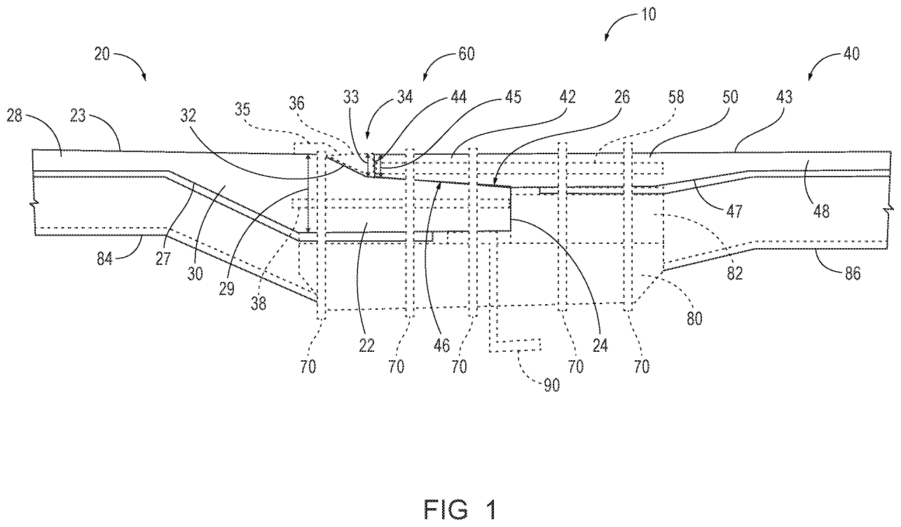

As schematically illustrated in FIG. 1, a circumferential skin joint 10 includes at least a first composite fuselage member 20 and a second composite fuselage member 40. The first composite fuselage member 20 has a first composite skin 28, the first composite skin 28 including a first chamfer 22 that at least partially defines a first distal end 24 of the first composite fuselage member 20. Here, the first chamfer 22 defines a first tapered mating surface 26 that slopes toward the first distal end 24 of the first composite fuselage member 20. The first tapered mating surface 26 extends circumferentially around an outer surface 23 of the first composite fuselage member. Generally, the first tapered mating surface slopes axially (i.e., along an axis of the first composite fuselage member) and may have a substantially consistent slope around the circumference of the first composite fuselage member.

Similarly, the second composite fuselage member 40 has a second composite skin 48, the second composite skin 48 comprising a second chamfer 42 that at least partially defines a second distal end 44 of the second composite fuselage member 40. The second chamfer 42 defines a second tapered mating surface 46 that extends circumferentially around an inner surface 47 of the second composite fuselage member. Generally, the second tapered mating surface slopes axially (i.e., along an axis of the first composite fuselage member) and may have a substantially consistent slope around the circumference of the first composite fuselage member.

The first tapered mating surface 26 of the first composite fuselage member 20 contacts the second tapered mating surface 46 of the second composite fuselage member 40 to form a tapered lap joint 60 between the first composite fuselage member 20 and the second composite fuselage member 40. In other words, the circumferential skin joint 10 includes a lap joint 60 formed by two tapered surfaces (i.e., first tapered mating surface 26 and second tapered mating surface 46). Similarly, in other words, symmetrical sloping surfaces defined by the chamfers 22, 42 contact each other to form the tapered lap joint 60. In some examples, contact between the first tapered mating surface and the second tapered mating surface causes the first composite fuselage member and the second composite fuselage member to at least partially define a composite fuselage of an aerospace structure. In some examples, the tapered lap joint 60 comprises a scarf joint. In the example depicted in FIG. 1, the first chamfer 22 is interior to the second chamfer 42 at the tapered lap joint 60. Accordingly, the first composite fuselage member 20 is received by the second composite fuselage member 40. However, in some examples, the first chamfer is exterior to the second chamfer and the second composite fuselage member 40 is received by the first composite fuselage member 20. In some examples, the first composite fuselage member 20 and the second composite fuselage member 40 contact each other only at the tapered lap joint 60 (i.e., only the first tapered mating surface 26 and the second tapered mating surface 46 touch).

Circumferential tapered lap joints in accordance with the present teachings, such as the circumferential skin joint 10, couple aircraft skin components, such as barrels, half, barrels, segment skin panels, and/or the like together to form joined skin assemblies. While circumferential tapered lap joints as described herein are referred to as circumferential, tapered lap joints may be suitable for joining substantially planar components, components having complex cross-sections (i.e., including portions having different centers of curvature), components having ovular and/or elliptical cross-sections, and/or the like. In some examples, circumferential tapered lap joints in accordance with the present teachings extend around a transverse cross-section of a composite fuselage. The transverse cross-section may have any suitable shape, such as circular (e.g., when the composite fuselage comprises barrel segments), ovular, elliptical, stadium-shaped, rectangular, irregular, and/or the like.

In some examples, the first chamfer 22 comprises a decrease in an outer diameter of the first composite fuselage member 20 approaching the first distal end 24 and the second chamfer 42 comprises an increase in an inner diameter of the second composite fuselage member 40 approaching the second distal end 44. In some examples, the first composite fuselage member 20 and the second composite fuselage member 40 are at least partially cylindrical, at least substantially cylindrical, or cylindrical, and accordingly have both an inner diameter and an outer diameter. In some examples, the first composite fuselage member 20 and the second composite fuselage member 40 are substantially semi-cylindrical.

However, in some examples, the first composite fuselage member 20 and the second composite fuselage member 40 are substantially planar, have complex cross-sections, and/or are otherwise structured such that the first composite fuselage member and the second composite fuselage member do not have an inner diameter and an outer diameter. Accordingly, in some examples, the first chamfer 22 comprises a taper of the outer surface 23 of the first composite fuselage member 20 toward a centerline of the fuselage as the first chamfer approaches the first distal end 24 and the second chamfer 42 comprises a taper of the inner surface 47 of the second composite fuselage member 40 away from the centerline of the fuselage as the second chamfer approaches the second distal end 44.

When compared to conventional joints, the circumferential skin joint 10 has several benefits. As the circumferential skin joint 10 only includes two members, the first composite fuselage member 20 and the second composite fuselage member 40, that are coupled directly to each other, a production rate of the circumferential skin joint may be increased. Conventional joints require each skin component to be coupled to a common splice strap, effectively requiring twice the fastening steps of the circumferential skin joint 10. Additionally, the circumferential skin joint 10 may not require shimming, as gaps between the first composite fuselage member and the second composite fuselage member may be addressed by sliding the first composite fuselage member and the second composite fuselage member relative to each other along a longitudinal axis of the fuselage. Furthermore, fewer fasteners are required to couple the first composite fuselage member directly to the second composite fuselage member, reducing an overall part count, recurring cost, and weight of the aerospace structure, as well as a manufacturing time of the fuselage.

Tapered lap joints 60 facilitate stove piping assembly processes. In some examples, slopes and/or angles of the tapered lap joints may be adjusted by mandrel tool compensation and/or precision machining of the first tapered mating surface and the second tapered mating surface. Accordingly, the first tapered mating surface 26 and the second tapered mating surface 46 may each have any suitable slope, or steepness, such as: at least 5:1, at least 8:1, at least 9:1, or at least 10:1; and at most 20:1, at most 15:1, at most 12:1, or at most 10:1. In some examples, the slope of the first tapered mating surface or the second tapered mating surface is defined as the ratio between the radial change (i.e., a taper towards or away from a centerline of the fuselage) and the axial change (i.e., a total length of the tapered mating surface) along the length of the tapered mating surface. Tapered mating surfaces having steeper slopes may provide narrower circumferential skin joints, reducing a total number of required fasteners and increasing a number of windows that may be included within an aircraft. In contrast, tapered mating surfaces having gentler slopes may provide increased adjustability of fuselage length and gap size, facilitating improved gap management when assembling an aerospace structure including the circumferential skin joint 10.

The first composite fuselage member 20 and the second composite fuselage member 40 overlap to form the tapered lap joint 60. Accordingly, no gap is formed between the first composite fuselage member and the second composite fuselage member and/or between the first composite skin and the second composite skin thereof. Furthermore, the first chamfer 22 can be fastened directly to the second chamfer 42, reducing the need for splice straps when fastening the first composite fuselage member to the second composite fuselage member. Additional manufacturing steps, such as shimming, are reduced and/or eliminated. Furthermore, the first and second tapered mating surfaces 26, 46 facilitate adjustment of the tapered lap joint. The first tapered mating surface 26 and the second tapered mating surface 46 may slide along each other during assembly, allowing precise control of relative heights of exterior surfaces of the first composite fuselage member and the second composite fuselage member. In some examples, sliding the first tapered mating surface against the second tapered mating surface causes the first composite fuselage member to be recessed relative to the second composite fuselage member. In some examples, sliding the first tapered mating surface against the second tapered mating surface causes the second composite fuselage member to be recessed relative to the first composite fuselage member.

As depicted in FIG. 1, thicknesses of the first composite fuselage member and the second composite fuselage member vary along the axial direction. Accordingly, in some examples, the first composite skin 28 includes a first reinforced portion 30 having a thickness greater than a thickness of the first composite skin in an area spaced apart from the circumferential joint. The increased thickness of the first reinforced portion provides increased strength and durability. In some examples, the first reinforced portion effectively substitutes for splice straps commonly used in conventional joints. As additional material is integrated into the first composite skin, supplementary material such as provided by splice straps and fillers may be unnecessary. In some examples, the splice straps are integrally laminated, interleaved, and/or imbedded into laminates forming the first composite fuselage member. Splice straps typically have a thickness roughly equal to a thickness of the first composite skin. Accordingly, in some examples, a maximum thickness 29 of the first reinforced portion is approximately 2× a thickness of the first composite skin, such that a total thickness of the tapered lap joint is at least twice a thickness of the first composite skin. In some examples, the maximum thickness 29 of the first reinforced portion is at least from 1.5× to 2.5×, from 1.75× to 2.15×, or from 1.9× to 2.1× the thickness of the first composite skin. In some examples, a total thickness of the tapered lap joint is substantially equal to the maximum thickness 29 of the first reinforced portion. Accordingly, in some examples, maximum thickness 29 at least twice the thickness of the first composite skin, such that the maximum thickness 29 is at least the thickness of the first composite skin plus the thickness of a typical splice strap.

In some examples, the thickness of the first reinforced portion 30 gradually increases from the thickness of the first composite skin 28 to the maximum thickness 29. In other words, an inner surface of the first composite skin 28 comprises a ramp 27 between the thickness of the first composite skin 28 and the maximum thickness 29. In some examples, such as when the first composite fuselage member is at least partially cylindrical, at least substantially cylindrical, or cylindrical, the increase in thickness comprises a decrease in an inner diameter of the first composite fuselage member 20 in a direction approaching the first distal end 24. In other words, in some examples, an inner surface of the of the first composite fuselage member 20 tapers toward a centerline of the fuselage in a direction approaching the first distal end 24. In some examples, the maximum thickness 29 may be adjacent to chamfer 22, such that the ramp 27 terminates before the first chamfer 22 begins. The ramp 27 may have any suitable slope, such as from 10:1 to 50:1.

In some examples, the first reinforced portion 30 further comprises a ramped junction 32 between an outer surface of the first composite skin 28 and the first chamfer 22. In some examples, such as when the first composite fuselage member comprises a barrel, half barrel, and/or other suitable curved component, the ramped junction comprises a decrease in an outer diameter of the first composite skin 28. In some examples, such as when the first composite fuselage member comprises a panel, the ramped junction comprises a portion of the outer surface of first composite skin 28 that slopes toward a centerline of the fuselage. In some examples, the ramped junction has a slope different from a slope of the first tapered mating surface. In some examples, the ramped junction has a steeper slope than the first tapered mating surface. In other words, the ramped junction 32 and the first chamfer 22 collectively form a tapered member for a half-lap joint.

A height 33 of the ramped junction 32 may be tailored to change aerodynamic properties of a fuselage including the circumferential skin joint 10. In some examples, the ramped junction 32 has a height and/or rise 33 substantially equivalent to a thickness 45 of the second distal end 44, such that the outer surface 23 of the first composite fuselage member 20 and an outer surface 43 of the second composite fuselage member 40 are substantially flush. In some examples, the ramped junction 32 has a height 33 less than a thickness 45 of the second distal end, such that the outer surface 23 of the first composite fuselage member 20 is recessed relative to the outer surface 43 of the second composite fuselage member 40. In these examples, the second composite fuselage member 40 is configured to be forward of the first composite fuselage member 20 when the two composite fuselage members are included in an aircraft or other aerospace structure. In other words, when the fuselage is in use, airflow flows from right to left in the view depicted by FIG. 1. In these examples, the second composite fuselage member 40 protects the outer surface 23 of the first composite fuselage member from airstream erosion damage, such that use of erosion protection foil on the first composite fuselage member is unnecessary. The first tapered mating surface 26 and the second tapered mating surface 46 may slide along each other during assembly (i.e., during a stove-piping process), allowing precise control of relative heights of exterior surfaces of the first composite fuselage member and the second composite fuselage member. In some examples, sliding the first tapered mating surface against the second tapered mating surface causes the first composite fuselage member to be recessed relative to the second composite fuselage member. In some examples, the outer surface 23 of the first composite fuselage member tapers towards a centerline of the fuselage in a direction approaching the tapered lap joint 60, such that the outer surface 23 of the first composite fuselage member 20 is recessed relative to the outer surface 43 of the second composite fuselage member 40.

In some examples, erosion protection foil 35 is installed such that the erosion protection foil is covering the ramped junction 32. The erosion protection foil may comprise any suitable protective substance, such as titanium, aluminum, and/or the like. Erosion protection foils protect composite materials from peeling due to rain, but frequently need to be replaced due to a lack of durability. As the ramped junction 32 comprises a downward-sloping portion of the first composite skin 28, installing erosion protection foil over the ramped junction is simpler and more durable than installing the erosion protection foil over a sharp corner, such as over the second distal end 44 and/or over the edges of butt-joined skins, such as those used in conventional circumferential joints.

In alternate examples, first composite fuselage member 20 may be configured to be forward of the second composite fuselage member 40. In such examples, the ramped junction 32 has a height 33 greater than a thickness 45 of the second distal end 44, such that the outer surface of the first composite fuselage member 20 protects the second distal end 44 from airstream erosion damage. In other words, in this example, when the fuselage is in use, airflow flows from left to right in the view depicted by FIG. 1.

In some examples, the ramped junction 32 defines a recess 34 between the first composite fuselage member 20 and the second distal end 44. In other words, the recess 34 is defined by the ramped junction 32 and the second distal end 44. In some examples, the recess is at least partially filled with a sealant 36, which is configured to seal gaps between the first composite fuselage member 20 and the second composite fuselage member 40. The sealant 36 may comprise any suitable sealant for aerospace applications, such as aero sealant, polysulfide adhesive, silicone, urethane, and/or the like.

The ramped junction 32 may have any suitable slope, such as at least 7:1, at least 8:1, at least 9:1, at least 10:1, at most 14:1, at most 13:1, at most 12:1, at most 11:1, at most 10:1, and/or any suitable combination thereof. The first reinforced portion 30 may have any suitable maximum thickness, such as from 1.5× to 2.5×, from 1.75× to 2.15×, and/or from 1.9× to 2.1× a maximum thickness of the first chamfer, and/or the like, such that the tapered lap joint 60 substantially resembles a half lap joint with respect to the first composite fuselage member 20.

Similarly, in some examples, the second composite skin 48 further comprises a second reinforced portion 50, wherein a thickness of the second reinforced portion 50 is greater than a thickness of the second composite skin 48. In some examples, a maximum thickness of the second reinforced portion 50 is from 1.1× to 1.25× a thickness of the second composite skin 48. In some examples, a maximum thickness of the second reinforced portion 50 is from 1.25× to 1.5× a thickness of the second composite skin 48. In some examples, a maximum thickness of the second reinforced portion 50 is at least 1.5× a thickness of the second composite skin 48. In some examples, a maximum thickness of the second reinforced portion 50 is at least twice the thickness of the second composite skin 48.

Generally, the second reinforced portion 50 has a thickness less than maximum thickness 29 of the first reinforced portion 30. In some examples, a maximum thickness of the second reinforced portion 50 is approximately half of maximum thickness 29 of the first reinforced portion 30, such that the first composite fuselage member 20 and the second composite fuselage member 40 effectively form a half-lap joint. In some examples, the maximum thickness of the second reinforced portion 50 is from 40% to 60% of maximum thickness 29. In some examples, a maximum thickness of the second reinforced portion 50 is substantially similar to a height of the ramped junction 32 plus a height (i.e., rise) of the first tapered mating surface 26.

In some examples, the first composite fuselage member 20 and the second composite fuselage member 40 comprise layered composite materials. Layered composite materials generally comprise at least one layer of fibrous composite material impregnated with resin. The at least one layer of fibrous composite material may comprise sheets of any suitable fibrous material, such as fiberglass, carbon fiber, polyaramid, and/or the like. The sheets of fibrous material may be impregnated with any suitable curable polymer, such as epoxy resin, phenolic resin, thermoplastics, rubbers, resins, and/or the like. In some examples, fibers included in the sheets of fibrous material are woven. In some examples, fibers included in the sheets of fibrous material form nonwoven fabrics.

Accordingly, in some examples, the first composite fuselage member 20 comprises a first layered composite material that includes a plurality of first layers of composite material and the second composite fuselage member 40 comprises a second layered composite material that includes a plurality of second layers of composite material. The first layered composite material and the second layered composite material may include integrally-laminated layers of material configured to perform the functions of aircraft components typically coupled externally to fuselage members, such as tear straps, splice straps, and/or the like. The integrally-laminated layers of material may be oriented at a variety of angles relative to the longitudinal axis of the fuselage 100, such as at a 0° angle, a 45° angle, a 90° angle, and/or the like. Reinforced portions 30, 50 may replace splice straps, by including regions of increased thickness in portions of the first composite skin 28 and the second composite skin 48 proximate to the tapered lap joint 60. In other words, the first composite fuselage member 20 and the second composite fuselage member 40 each comprise a respective reinforced portion 30, 50 including integrally laminated splice straps interleaved with the plurality of first layers of composite material and the plurality of second layers of composite material, providing an increased thickness of the first composite fuselage member 20 and the second composite fuselage member 40 at the tapered lap joint 60.

Similarly, in some examples, the first composite fuselage member 20 further comprises fail-safety straps, such as a plurality of first tear straps 38 integrally laminated within the plurality of first layers of composite material. The tear straps 38 are spaced apart and distributed about a circumference of the fuselage 100, such that discontinuity between the tear straps prevents cracks from propagating throughout the first composite fuselage member. In some examples, the plurality of first tear straps 38 is oriented along a longitudinal axis of the fuselage. Accordingly, in some examples, the plurality of first tear straps 38 includes first tear strap fibers oriented along a longitudinal axis of the first composite fuselage member. The first composite fuselage member 20 may include any suitable number of layers of tear straps integrally laminated within the plurality of first layers of composite material, such as at least one, at least two, at least three, at least four, at least five, at most ten, at most nine, at most eight, at most seven, at most six, and at most five tear strap layers. Similarly, the first composite fuselage member 20 may include any suitable number of tear straps distributed about a circumference of the fuselage 100, such as at least ten, at least twenty, at least thirty tear straps, and/or the like. The plurality of first tear straps may have any suitable dimensions relative to the tapered lap joint, such as having a length at least equal to, at least twice, at least three times, at least four times, at least five times, at most eight times, at most seven times, at most six times, or at least five times the width of the tapered lap joint, and/or any suitable combination thereof. In some examples, the length of the plurality of first tear straps is measured along the longitudinal axis of the first composite fuselage member.

Similarly, in some examples, the second composite fuselage member 40 further comprises fail-safety straps, such as a plurality of second tear straps 58 integrally laminated within the plurality of second layers of composite material. As described above, the tear straps 58 prevent cracks from propagating throughout the second composite fuselage member. In some examples, the plurality of second tear straps 58 are oriented along a longitudinal axis of the fuselage. Accordingly, in some examples, the plurality of second tear straps 58 includes second tear strap fibers oriented along a longitudinal axis of the first composite fuselage member. The second composite fuselage member 40 may include any suitable number of layers of tear straps integrally laminated within the plurality of second layers of composite material, such as at least one, at least two, at least three, at least four, at least five, at most ten, at most nine, at most eight, at most seven, at most six, and at most five tear strap layers. Similarly, the second composite fuselage member 40 may include any suitable number of tear straps distributed about a circumference of the fuselage 100, such as at least ten, at least twenty, at least thirty tear straps and/or the like. The plurality of second tear straps may have any suitable dimensions relative to the tapered lap joint, such as having a length at least equal to, at least twice, at least three times, at least four times, at least five times, at most eight times, at most seven times, at most six times, or at least five times the width of the tapered lap joint, and/or any suitable combination thereof. In some examples, the length of the plurality of second tear straps is measured along the longitudinal axis of the second composite fuselage member.

In some examples, and as illustrated in dashed lines in FIG. 1, the circumferential skin joint 10 further comprises a plurality of fasteners 70 extending through the first chamfer 22 and the second chamfer 42, such that the plurality of fasteners couple the first composite fuselage member 20 to the second composite fuselage member 40. While FIG. 1 depicts a cross-section of the circumferential skin joint 10, it is understood that the fasteners 70 are distributed around the circumference of the circumferential skin joint. The fasteners 70 may comprise any suitable fasteners for coupling two aerospace components together, such as bolts, nuts, rivets, pins, and/or the like. In some examples, the fasteners 70 are distributed evenly around the circumference of a fuselage including the circumferential skin joint 10.

In some examples, the fasteners 70 are augmented and/or replaced by an adhesive applied to the first tapered mating surface 26 and the second tapered mating surface 46. Accordingly, in some examples, the first tapered mating surface 26 is bonded to the second tapered mating surface 46. In some examples, the first tapered mating surface 26 is bonded to the second tapered mating surface using any suitable substance, such as anaerobic adhesive, epoxy, acrylic adhesive, UV-activated adhesive, polyurethane, polymer adhesives, and/or the like. In some examples, the first tapered mating surface 26 is bonded to the second tapered mating surface 46 using thermoplastic welding.

In some examples, a first fastener of the plurality of fasteners 70 extends through both the first chamfer 22 and the second chamfer 42. Similarly, in some examples, a second fastener of the plurality of fasteners 70 extends through both the first chamfer 22 and the second chamfer 42. In some examples, at least three fasteners extend through both the first chamfer 22 and the second chamfer 42.

In some examples, as illustrated in dashed lines in FIG. 1, the circumferential skin joint 10 further comprises a stringer fitting 80 coupled to the first composite fuselage member 20 by a first fastener of the plurality of fasteners 70 and coupled to the second composite fuselage member 40 by a second fastener of the plurality of fasteners 70. The stringer fitting 80 is configured to provide increased support of the circumferential skin joint 10. In other words, the stringer fitting 80 transfers loads from the first composite skin 28 and the second composite skin 48, and corresponding stringers 84, 86 across the circumferential skin joint 10. The stringer fitting 80 comprises any suitable supportive beam having any suitable cross-section, such as an I-beam, T-bar, L-angle, and/or the like. In some examples, the stringer fitting 80 extends along a longitudinal axis of the first composite fuselage member and the second composite fuselage member and projects radially (i.e., towards a shared center of curvature of the first composite fuselage member and second composite fuselage member).

In some examples, at least two fasteners of the plurality of fasteners 70 both extend through the first chamfer 22, the second chamfer 42, and the stringer fitting 80, such that the stringer fitting 80 is coupled at two locations to both the first composite fuselage member 20 and the second composite fuselage member 40. In some examples, a first fastener of the plurality of fasteners 70 is coupled to the first reinforced portion 30 and a second fastener of the plurality of fasteners 70 is coupled to the second reinforced portion 50. In some examples, the first fastener extends through both the first reinforced portion 30 and the stringer fitting 80 and the second fastener extends through both the second reinforced portion 50 and the stringer fitting 80. In these examples, the stringer fitting 80 is coupled to regions of the first composite fuselage member 20 and the second composite fuselage member 40 adjacent to the tapered lap joint 60. In some examples, the circumferential skin joint 10 further comprises two or more additional fasteners 70 extending through the first chamfer 22 and the second chamfer 42. In some examples, additional fasteners 70 extend through the first chamfer 22, the second chamfer, 42, and the stringer fitting 80, such that at least four fasteners couple the stringer fitting 80 to the first and second composite fuselage members.

The stringer fitting 80 may have any suitable shape configured to conform to the first composite fuselage member 20 and the second composite fuselage member 40. In some examples, a shape of the stringer fitting 80 is complementary to an interior profile of the tapered lap joint 60. In some examples, the stringer fitting 80 is directly coupled to the second composite fuselage member 40. In some examples, the stringer fitting 80 has an L-shaped cross-section, such that a shape of the stringer fitting 80 accommodates a thickness of first distal end 24. In some examples, the stringer fitting 80 has a cross-section having a substantially linear profile, rectangular profile, trapezoidal profile, and/or the like. As the first distal end 24 has a thickness, directly coupling the stringer fitting 80 to the second composite fuselage member may include joggling (i.e., axially bending) the stringer fitting 80, the first composite fuselage member 20, and/or the second composite fuselage member 40, such that a first end of the stringer fitting 80 is coupled to the first composite fuselage member 20 and a second end of the stringer fitting 80 is coupled to the second composite fuselage member 40.

In some examples, as illustrated in dashed lines in FIG. 1, a filler 82 is disposed between the stringer fitting 80 and the second composite fuselage member 40. In some examples, the filler 82 has a thickness substantially similar to the thickness of the first distal end 24. Accordingly, in some examples, the stringer fitting 80 directly contacts the filler 82, which directly contacts the second composite fuselage member 40. In other words, in some examples, the first fastener extends through the first composite fuselage member 20 and the stringer fitting 80, and the second fastener extends through the second composite fuselage member 40, the filler 82, and the stringer fitting 80. The filler 82 may comprise any suitable material for use in aerospace structures. In some examples, the filler 82 comprises a co-cured composite material, such as composite materials utilized in the first composite fuselage member 20 and the second composite fuselage member 40.

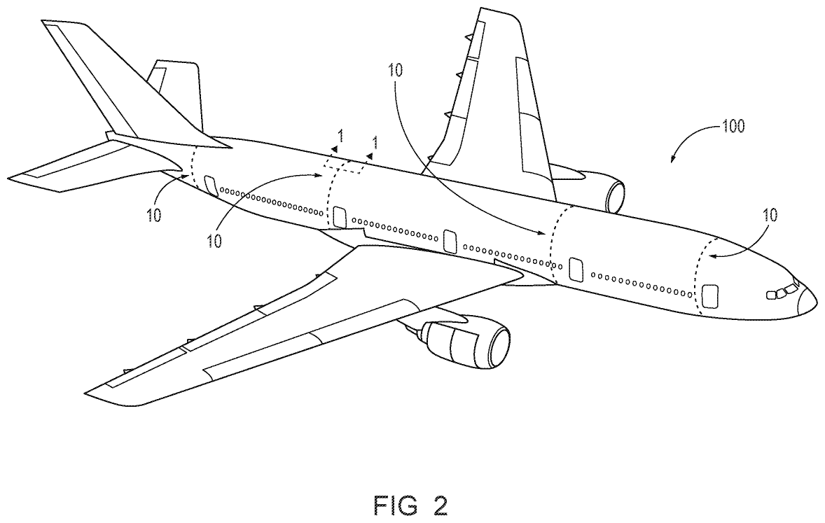

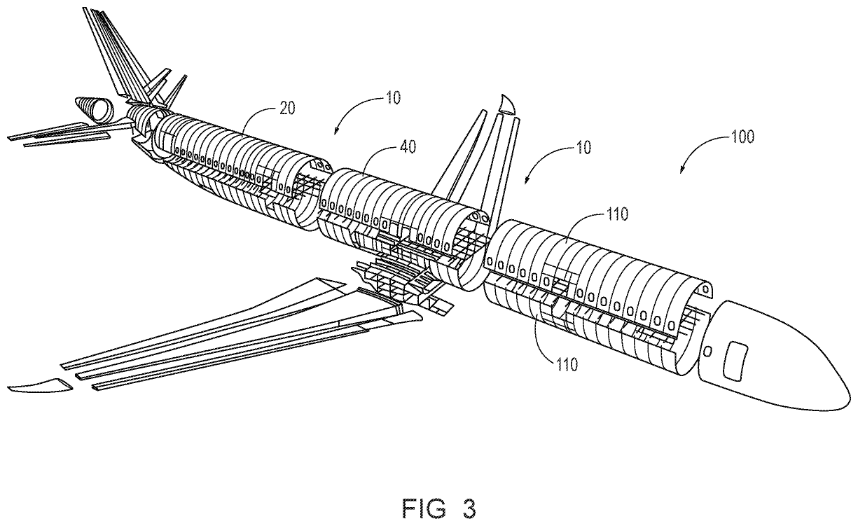

As schematically illustrated in FIGS. 2 and 3 a fuselage 100 of an aerospace structure may comprise at least one circumferential skin joint 10 as described above with respect to FIG. 1. In the example depicted in FIGS. 2 and 3, the fuselage 100 includes four circumferential skin joints 10 coupling segments of the fuselage 100 together. However, the fuselage 100 may include any suitable number of circumferential skin joints 10, such as greater than or equal to one, greater than or equal to two, greater than or equal to four, greater than or equal to six, and/or the like. FIG. 2 depicts the fuselage 100 in an assembled configuration, and FIG. 3 depicts an exploded view of the fuselage 100. In the example of FIG. 3, the fuselage 100 comprises six half-barrel segments 110. The half-barrel segments are joined together at the circumferential skin joints 10 to form the fuselage.

The circumferential skin joint 10 may be disposed in any suitable location in a fuselage. As schematically illustrated in dashed lines in FIG. 1, the circumferential skin joint 10 is located at a frame station 90 of the fuselage including the circumferential skin joint. The frame station 90 is aligned with the circumferential skin joint 10, such that the frame station 90 overlaps with the first chamfer 22 and the second chamfer 42. In contrast, circumferential skin joints 200, 300, and 400, described below, are located mid-bay (e.g., between frame stations or fuselage frames).

In the example depicted in FIGS. 2 and 3, the second composite fuselage member 40 is disposed forward of the first composite fuselage member 20. Accordingly, the second composite fuselage member 40 may protect the outer surface 23 of the first composite fuselage member 20 from airstream erosion damage, as discussed herein. However, in some examples, the first composite fuselage member 20 is disposed forward of the second composite fuselage member 40.

The fuselage 100 may form the fuselage of any suitable aerospace structure, such as an aircraft, spacecraft, satellite, rocket, and/or the like.

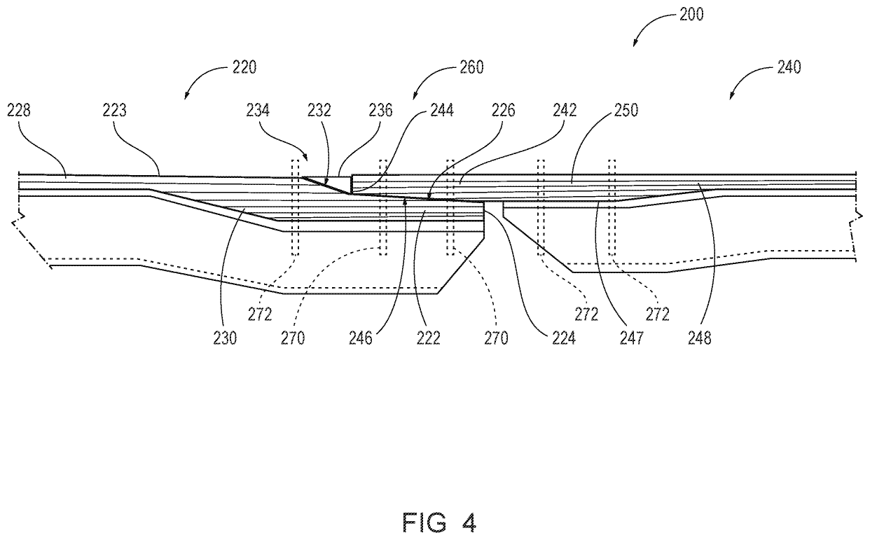

Turning now to FIGS. 4-7, illustrative non-exclusive examples of circumferential skin joints 10 are illustrated. Where appropriate, the reference numerals from the schematic illustrations of FIG. 1 are used to designate corresponding parts of the examples of FIGS. 4-7, however, the examples of FIGS. 4-7 are non-exclusive and do not limit circumferential skin joints 10 to the illustrated embodiments of FIGS. 4-7. That is, circumferential skin joints 10 are not limited to the specific embodiments of FIGS. 4-7, and circumferential skin joints 10 may incorporate any number of the various aspects, configurations, characteristics, properties, etc. of circumferential skin joints 200, 300, 400, and 500 that are illustrated in and discussed with reference to the schematic representations of FIG. 1 and/or the embodiments of FIGS. 4-7, as well as variations thereof, without requiring the inclusion of all such aspects, configurations, characteristics, properties, etc. For the purpose of brevity, each previously discussed component, part, portion, aspect, region, etc. or variants thereof may not be discussed, illustrated, and/or labeled again with respect to the examples of FIGS. 4-7; however, it is within the scope of the present disclosure that the previously discussed features, variants, etc. may be utilized with the examples of FIGS. 4-7.

As seen in FIG. 4, circumferential skin joint 200 is an example of a circumferential skin joint 10 that includes a first composite fuselage member 220 and a second composite fuselage member 240. First composite fuselage member 220 has a first composite skin 228, the first composite skin 228 including a first chamfer 222 that at least partially defines a first distal end 224 of the first composite fuselage member 220. The first chamfer 222 defines a first tapered mating surface 226 that slopes toward the first distal end 224 of the first composite fuselage member 220. The first tapered mating surface 226 extends circumferentially around an outer surface 223 of the first composite fuselage member.

Similarly, the second composite fuselage member 240 has a second composite skin 248, the second composite skin 248 comprising a second chamfer 242 that at least partially defines a second distal end 244 of the second composite fuselage member 240. The second chamfer 242 defines a second tapered mating surface 246 that extends circumferentially around an inner surface 247 of the second composite fuselage member.

The first tapered mating surface 226 of the first composite fuselage member 220 contacts the second tapered mating surface 246 of the second composite fuselage member 240 to form a tapered lap joint 260 between the first composite fuselage member 220 and the second composite fuselage member 240. In other words, the circumferential skin joint 200 includes a lap joint 260 formed by two tapered surfaces (i.e., first tapered mating surface 226 and second tapered mating surface 246). In some examples, the first tapered mating surface and the second tapered mating surface at least partially define a composite fuselage of an aerospace structure. In the example depicted in FIG. 4, the first chamfer 222 is interior to the second chamfer 242 at the tapered lap joint 260. Accordingly, the first composite fuselage member 220 is received by the second composite fuselage member 240.

As described above with respect to FIG. 1 and circumferential skin joint 10, thicknesses of the first composite skin 228 and the second composite skin 248 vary along a longitudinal axis of the first composite fuselage member and the second composite fuselage member. Accordingly, the first composite skin 228 includes a first reinforced portion 230 and a ramped junction 232. The ramped junction 232 defines a recess 234 between the first composite fuselage member 220 and the second distal end 244. The recess 234 is filled with a sealant 236, as described above. The first reinforced portion 230 and the ramped junction 232 are substantially identical to the first reinforced portion 30 and the ramped junction 32, as described above. Similarly, the second composite skin 248 includes a second reinforced portion 250. The second reinforced portion 250 is substantially identical to the second reinforced portion 50, as described above.

As described above with respect to FIG. 1 and circumferential skin joint 10, composite material forming the first composite fuselage member and the second composite fuselage member includes integrally-laminated splice straps increasing a thickness of the fuselage members at the first reinforced portion 230 and the second reinforced portion 250. Accordingly, in some examples, stringer fittings such as stringer fitting 80 may be unnecessary due to the first reinforced portion 230 and the second reinforced portion 250. In the example depicted in FIG. 4, stringer fittings such as stringer fitting 80 are eliminated and replaced by the first reinforced portion 230 and the second reinforced portion 250. In some examples, the first composite fuselage member and the second composite fuselage member further comprise fail-safety straps, such as a plurality of tear straps integrally laminated within the composite material.

As depicted in FIG. 4, two fasteners 270 extend through the first chamfer 222 and the second chamfer 242, coupling the first composite fuselage member to the second composite fuselage member. In some examples, damage arrestment fasteners 272 extend through reinforced portions 230, 250. The damage arrestment fasteners 272 are configured to prevent failures such as delaminations, disbonds, cracks, and/or the like from propagating throughout the first composite fuselage member and the second composite fuselage member. The damage arrestment fasteners 272 may comprise any suitable fastener, such as bolts, nuts, rivets, pins, and/or the like.

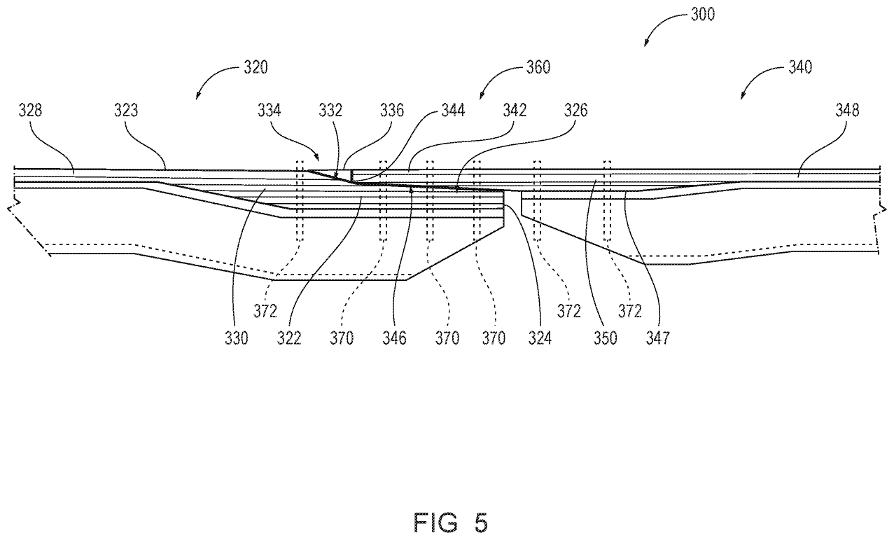

As seen in FIG. 5, circumferential skin joint 300 is an example of a circumferential skin joint 10 that includes a first composite fuselage member 320 and a second composite fuselage member 340. The first composite fuselage member 320 has a first composite skin 328, the first composite skin 328 including a first chamfer 322 that at least partially defines a first distal end 324 of the first composite fuselage member 320. The first chamfer 322 defines a first tapered mating surface 326 that slopes toward the first distal end 324 of the first composite fuselage member 320. The first tapered mating surface 326 extends circumferentially around an outer surface 323 of the first composite fuselage member.

Similarly, the second composite fuselage member 340 has a second composite skin 348, the second composite skin 348 comprising a second chamfer 342 that at least partially defines a second distal end 344 of the second composite fuselage member 340. The second chamfer 342 defines a second tapered mating surface 346 that extends circumferentially around an inner surface 347 of the second composite fuselage member.

The first tapered mating surface 326 of the first composite fuselage member 320 contacts the second tapered mating surface 346 of the second composite fuselage member 340 to form a tapered lap joint 360 between the first composite fuselage member 320 and the second composite fuselage member 340. In other words, the circumferential skin joint 300 includes a lap joint 360 formed by two tapered surfaces (i.e., first tapered mating surface 326 and second tapered mating surface 346). In some examples, the first tapered mating surface and the second tapered mating surface at least partially define a composite fuselage of an aerospace structure. In the example depicted in FIG. 5, the first chamfer 322 is interior to the second chamfer 342 at the tapered lap joint 360. Accordingly, the first composite fuselage member 320 is received by the second composite fuselage member 340.

As described above with respect to FIG. 1 and circumferential skin joint 10, thicknesses of the first composite skin 328 and the second composite skin 348 vary along a longitudinal axis of the first composite fuselage member and the second composite fuselage member. Accordingly, the first composite skin 328 includes a first reinforced portion 330 and a ramped junction 332. The ramped junction 332 defines a recess 334 between the first composite fuselage member 320 and the second distal end 344. The recess 334 is filled with a sealant 336, as described above. The first reinforced portion 330 and the ramped junction 332 are substantially identical to the first reinforced portion 30 and the ramped junction 32, as described above. Similarly, the second composite skin 348 includes a second reinforced portion 350. The second reinforced portion 350 is substantially identical to the second reinforced portion 50, as described above.

Similar to the example depicted in FIG. 4, composite material forming the first composite fuselage member and the second composite fuselage member includes integrally-laminated splice straps increasing a thickness of the composite fuselage members at the first reinforced portion 330 and the second reinforced portion 350. In some examples, the first composite fuselage member and the second composite fuselage member further comprise fail-safety straps, such as a plurality of tear straps integrally laminated within the composite material. As depicted in FIG. 5, three fasteners 370 extend through the first chamfer 322 and the second chamfer 342, coupling the first composite fuselage member to the second composite fuselage member. In some examples, damage arrestment fasteners 372 extend through reinforced portions 330, 350. The damage arrestment fasteners 372 are configured to prevent failures such as delaminations, disbonds, cracks, and/or the like from propagating throughout the first composite fuselage member and the second composite fuselage member. The damage arrestment fasteners 372 may comprise any suitable fastener, such as bolts, nuts, rivets, pins, and/or the like.

The circumferential skin joint 300 of FIG. 5 is substantially identical to the circumferential skin joint 200 depicted in FIG. 4, except that a slope of the first tapered mating surface 326 and the second tapered mating surface 346 is gentler (i.e., less steep) than a slope of the first tapered mating surface 226 and the second tapered mating surface 246. Accordingly, a contact area or common mating surface between the first tapered mating surface 326 and the second tapered mating surface 346 is comparatively larger, providing more space for a greater number of fasteners 370.

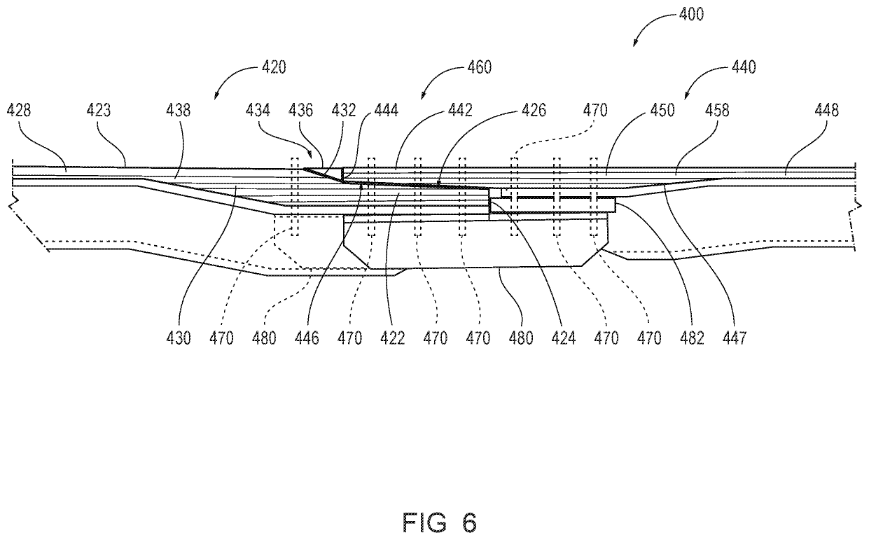

As seen in FIG. 6, circumferential skin joint 400 is an example of a circumferential skin joint 10 that includes a first composite fuselage member 420 and a second composite fuselage member 440. The first composite fuselage member 420 has a first composite skin 428, the first composite skin 428 including a first chamfer 422 that at least partially defines a first distal end 424 of the first composite fuselage member 420. The first chamfer 422 defines a first tapered mating surface 426 that slopes toward the first distal end 424 of the first composite fuselage member 420. The first tapered mating surface 426 extends circumferentially around an outer surface 423 of the first composite fuselage member.

Similarly, the second composite fuselage member 440 has a second composite skin 448, the second composite skin 448 comprising a second chamfer 442 that at least partially defines a second distal end 444 of the second composite fuselage member 440. The second chamfer 442 defines a second tapered mating surface 446 that extends circumferentially around an inner surface 447 of the second composite fuselage member.

The first tapered mating surface 426 of the first composite fuselage member 420 contacts the second tapered mating surface 446 of the second composite fuselage member 440 to form a tapered lap joint 460 between the first composite fuselage member 420 and the second composite fuselage member 440. In other words, the circumferential skin joint 400 includes a lap joint 460 formed by two tapered surfaces (i.e., first tapered mating surface 426 and second tapered mating surface 446). In some examples, the first tapered mating surface and the second tapered mating surface at least partially define a composite fuselage of an aerospace structure. In the example depicted in FIG. 6, the first chamfer 422 is interior to the second chamfer 442 at the tapered lap joint 460. Accordingly, the first composite fuselage member 420 is received by the second composite fuselage member 440.

As described above with respect to FIG. 1 and circumferential skin joint 10, thicknesses of the first composite skin 428 and the second composite skin 448 vary along a longitudinal axis of the first composite fuselage member and the second composite fuselage member. Accordingly, the first composite skin 428 includes a first reinforced portion 430 and a ramped junction 432. The ramped junction 432 defines a recess 434 between the first composite fuselage member 420 and the second distal end 444. The recess 434 is filled with a sealant 436, as described above. The first reinforced portion 430 and the ramped junction 432 are substantially identical to the first reinforced portion 30 and the ramped junction 32, as described above. Similarly, the second composite skin 448 includes a second reinforced portion 450. The second reinforced portion 450 is substantially identical to the second reinforced portion 50, as described above.

The circumferential skin joint 400 further comprises a stringer fitting 480 coupled to the first composite fuselage member 420 and the second composite fuselage member 440 by at least two fasteners 470. The stringer fitting 480 is configured to provide increased support of the circumferential skin joint 400, and is substantially identical to the stringer fittings 80 as described above with respect to FIG. 1. As depicted in FIG. 6, at least three fasteners 470 extend through the first chamfer 422, the second chamfer 442, and the stringer fitting 480. However, any suitable number of fasteners may couple the first chamfer 422 and the second chamfer 442 to the stringer fitting 480. and/or

The stringer fitting 480 is further coupled to the second composite fuselage member 440 by at least two fasteners 470. In the example depicted in FIG. 6, at least three fasteners 470 extend through the first chamfer 422, the second chamfer 442, and the stringer fitting 480. However, any suitable number of fasteners 470 may be used, such as in the example of FIG. 1, where two fasteners extend through the first chamfer and the second chamfer. As depicted in FIG. 6, a filler 482 is disposed between the stringer fitting 480 and the second composite fuselage member 440. In some examples, the filler 482 has a thickness substantially similar to a thickness of the first distal end 424. Accordingly, in some examples, the stringer fitting 480 directly contacts the filler 482, which directly contacts the second composite fuselage member 440. The filler 482 may comprise any suitable material for use in aerospace structures. In some examples, the filler 482 comprises a co-cured composite material, such as composite materials utilized in the filler 82, as described above with respect to FIG. 1.

In some examples, as depicted in dashed lines in FIG. 6, the stringer fitting 480 extends beyond the tapered lap joint 460, such that at least one fastener 470 may extend through the first composite fuselage member 420 and the stringer fitting 480. Extending the stringer fitting in this manner may facilitate the application of symmetrical loads across the circumferential skin joint.

As described above with respect to FIG. 1, the first composite fuselage member 420 and the second composite fuselage member 440 each comprise layered composite materials comprising one or more layers of fibrous composite material 438, 458. In some examples, the first composite fuselage member and the second composite fuselage member include integrally-laminated splice straps increasing a thickness of the composite fuselage members at the first reinforced portion and the second reinforced portion. In some examples, the first composite fuselage member and the second composite fuselage member further comprise fail-safety straps, such as a plurality of tear straps integrally laminated within the composite material.

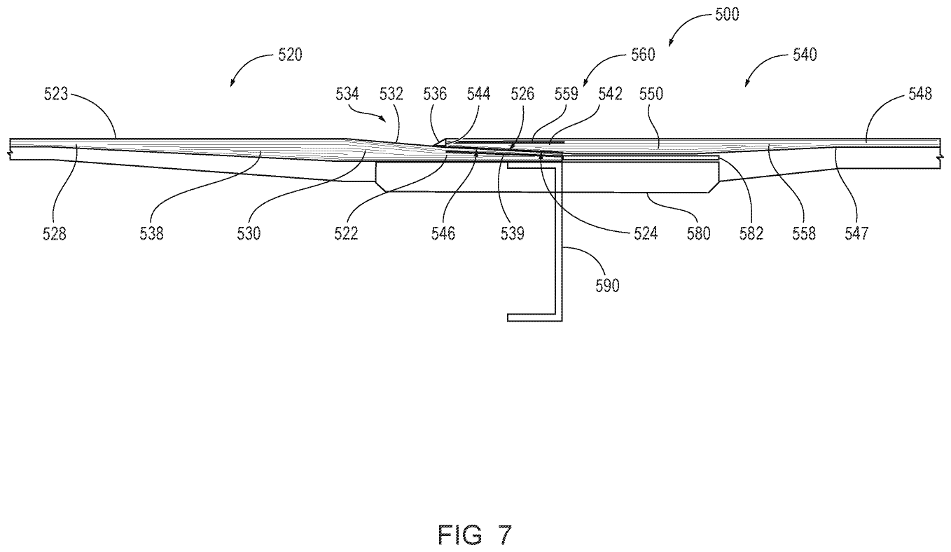

As seen in FIG. 7, circumferential skin joint 500 is an example of a circumferential skin joint 10 that includes a first composite fuselage member 520 and a second composite fuselage member 540. Circumferential skin joint 500 is substantially identical to circumferential skin joint 400, except as otherwise described. The first composite fuselage member 520 has a first composite skin 528, the first composite skin 528 including a first chamfer 522 that at least partially defines a first distal end 524 of the first composite fuselage member 520. The first chamfer 522 defines a first tapered mating surface 526 that slopes toward the first distal end 524 of the first composite fuselage member 520. The first tapered mating surface 526 extends circumferentially around an outer surface 523 of the first composite fuselage member.

Similarly, the second composite fuselage member 540 has a second composite skin 548, the second composite skin 548 comprising a second chamfer 542 that at least partially defines a second distal end 544 of the second composite fuselage member 540. The second chamfer 542 defines a second tapered mating surface 546 that extends circumferentially around an inner surface 547 of the second composite fuselage member.

The first tapered mating surface 526 of the first composite fuselage member 520 contacts the second tapered mating surface 546 of the second composite fuselage member 540 to form a tapered lap joint 560 between the first composite fuselage member 520 and the second composite fuselage member 540. In other words, the circumferential skin joint 500 includes a lap joint 560 formed by two tapered surfaces (i.e., first tapered mating surface 526 and second tapered mating surface 546). In some examples, the first tapered mating surface and the second tapered mating surface at least partially define a composite fuselage of an aerospace structure. In the example depicted in FIG. 7, the first chamfer 522 is interior to the second chamfer 542 at the tapered lap joint 560. Accordingly, the first composite fuselage member 520 is received by the second composite fuselage member 540.

As described above with respect to FIG. 1 and circumferential skin joint 10, thicknesses of the first composite skin 528 and the second composite skin 548 vary along a longitudinal axis of the first composite fuselage member and the second composite fuselage member. Accordingly, the first composite skin 528 includes a first reinforced portion 530 and a ramped junction 532. Similarly, the second composite skin 548 includes a second reinforced portion 550. The first reinforced portion 530 is substantially identical to the first reinforced portion 30, as described above. Similarly, the second reinforced portion 550 is substantially identical to the second reinforced portion 50, as described above. The ramped junction 532 defines a recess 534 between the first composite fuselage member 520 and the second distal end 544.

Ramped junctions included in circumferential skin joints may have a variety of suitable slopes. In the example depicted in FIG. 1, the recess 34 is at least partially filled with sealant 36, however, it may be impractical to completely fill a larger recess, such as recess 534, with sealant. Large surface-area regions of sealant may have different aerodynamic properties than the surrounding composite and further may be aesthetically unappealing. Instead, in the example of FIG. 7, a sealant 536 covers a corner of the distal end 544 and a portion of the ramped junction 532. The sealant 536 may comprise any suitable sealant for aerospace applications, such as aero sealant, polysulfide adhesive, silicone, urethane, and/or the like. The ramped junction 532 may have any suitable slope, such as at least 7:1, at least 8:1, at least 9:1, at least 10:1, at most 14:1, at most 13:1, at most 12:1, at most 11:1, at most 10:1, and/or any suitable combination thereof.

The circumferential skin joint 500 further comprises a stringer fitting 580 and a filler 582. The stringer fitting 580 and the filler 582 are substantially similar to the stringer fitting 80 and the filler 82 as described above with respect to FIGS. 1 and 6.

Circumferential skin joints in accordance with the present teachings may be disposed at any suitable location within the fuselage. As depicted in FIG. 7, the circumferential skin joint 500 is located at a frame station 590 of a fuselage including the circumferential skin joint. The frame station 590 is aligned with the circumferential skin joint 500, such that the frame station 590 overlaps with the first chamfer 522 and the second chamfer 542. In contrast, the circumferential skin joint 400 (as well as circumferential skin joints 200 and 300) are located mid-bay (i.e., between fuselage frames).

As described above with respect to FIG. 1, the first composite fuselage member 520 and the second composite fuselage member 540 each comprise layered composite materials comprising one or more layers of fibrous composite material 538, 558. In some examples, the first composite fuselage member and the second composite fuselage member include integrally-laminated splice straps increasing a thickness of the composite fuselage members at the first reinforced portion and the second reinforced portion. In some examples, the first composite fuselage member and the second composite fuselage member further comprise fail-safety straps, such as a plurality of tear straps 539, 559 integrally laminated within the composite material.

Layered composite materials according to the present teachings may have any suitable orientation generally extending along the longitudinal axis of the fuselage. In the example depicted in FIG. 7, one or more layers of fibrous composite material 538, 558 are oriented along the tapered mating surfaces 526, 546. In some examples, the one or more layers of first fibrous composite material 538 generally follow the contours of the outer surface 523 of the first composite fuselage member. Similarly, in some examples, the one or more layers of second fibrous composite material 558 generally follow the contours of the inner surface 547 of the second composite fuselage member. In some examples, composite fuselage members formed by laminating layers of fibrous composite material within a layup mandrel configured to compensate for the tapered mating surfaces have the illustrated configuration of layers. In some examples, composite fuselage members having tapered mating surfaces formed by precision machining have the illustrated configuration of layers, as sacrificial material configured to be removed during machining may be aligned with the tapered mating surfaces 526, 546. The configuration of layers depicted in FIG. 7 may be suitable for inclusion in circumferential skin joints 10, 200, 300, and 400.

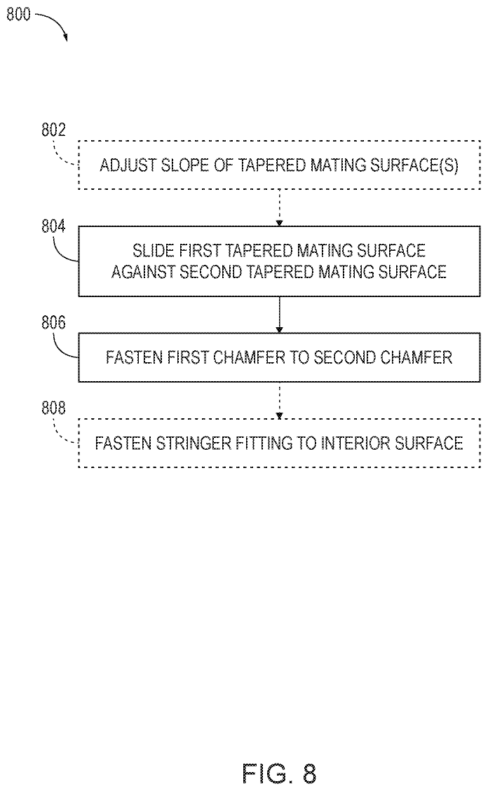

FIG. 8 schematically provides a flowchart that represents illustrative, non-exclusive examples of methods 800 according to the present disclosure. In FIG. 8, some steps are illustrated in dashed boxes indicating that such steps may be optional or may correspond to an optional version of a method according to the present disclosure. That said, not all methods according to the present disclosure are required to include the steps illustrated in solid boxes. The methods and steps illustrated in FIG. 8 are not limiting and other methods and steps are within the scope of the present disclosure, including methods having greater than or fewer than the number of steps illustrated, as understood from the discussions herein. Aspects of circumferential skin joints 10, 200, 300, 400, and 500 may be utilized in the method steps described below. Where appropriate, reference may be made to components and systems that may be used in carrying out each step. These references are for illustration, and are not intended to limit the possible ways of carrying out any particular step of the method.

As seen in FIG. 8, step 804 of method 800 includes sliding a first tapered mating surface of a first composite fuselage member against a second tapered mating surface of a second composite fuselage member. In some examples, the first composite fuselage member is substantially similar to the first composite fuselage member 20 and the second composite fuselage member is substantially similar to the second composite fuselage member 40, described above with respect to FIG. 1. Accordingly, in some examples, the first composite fuselage member includes a first composite skin comprising a first chamfer that defines a first tapered mating surface that extends circumferentially around an outer surface of the first composite fuselage member. Similarly, in some examples, the second composite skin comprises a second chamfer that defines a second tapered mating surface that extends circumferentially around an inner surface of the second composite fuselage member. Accordingly, in some examples, the sliding the first tapered mating surface against the second tapered mating surface includes sliding the first tapered mating surface against the second tapered mating surface such that the first chamfer is interior to the second chamfer.

Sliding, as used in step 804, refers to axial sliding of the first tapered mating surface of the first composite fuselage member and the second tapered mating surface the second composite fuselage member. In other words, step 802 refers to sliding the first composite fuselage member along a longitudinal axis of the first composite fuselage member, such that relative heights of outer surfaces of the first composite fuselage member and the second composite fuselage member are adjusted, such that overlap between the first composite fuselage member and the second composite fuselage member is adjusted, or increased, and/or such that an area of contact between the first composite fuselage member and the second composite fuselage member is adjusted, or increased.

While step 804 refers to axial sliding, in some examples, method 800 further includes rotating and/or laterally translating the first composite fuselage member with respect to the second composite fuselage member, such that central axes of the first composite fuselage member and the second composite fuselage member are aligned. In some examples, sliding the first tapered mating surface against the second tapered mating surface along the longitudinal axis of the first composite fuselage member includes adjusting a length of a fuselage that includes the first composite fuselage member and the second composite fuselage member. In some examples, sliding the first tapered mating surface against the second tapered mating surface along the longitudinal axis of the first composite fuselage member facilitates gap management at the circumferential skin joint by adjusting a degree of overlap between the first and second composite fuselage members. Furthermore, as the first composite fuselage member overlaps with the second composite fuselage member, gaps extending through a thickness of the fuselage are avoided.

In some examples, the first composite fuselage member and the second composite fuselage member are substantially cylindrical, and sliding the first tapered mating surface against the second tapered mating surface causes the first chamfer to be received at least partially within the second composite fuselage member (e.g., in a stove-piping process.

In some examples, step 804 includes one or more preparatory steps configured to align the first composite fuselage member and the second composite fuselage member. In some examples, step 804 includes coaxially aligning the first composite fuselage member and the second composite fuselage member. In some examples, step 804 includes rotationally aligning the first composite fuselage member and the second composite fuselage member. In some examples, step 804 includes altering a shape of the first composite fuselage member and/or the second composite fuselage member to promote stove-piping.

Step 806 of method 800 includes fastening the first chamfer to the second chamfer to define the circumferential skin joint between the first composite fuselage member and the second composite fuselage member and to at least partially define a composite fuselage of an aerospace structure. Fastening the first chamfer to the second chamfer to define the circumferential skin joint may comprise any suitable method, such as bolting, bonding, and/or the like. In some examples, fastening the first chamfer to the second chamfer includes bolting the first chamfer to the second chamfer. In some examples, fastening the first chamfer to the second chamfer includes bonding the first chamfer to the second chamfer using an adhesive such as anaerobic adhesive, epoxy, acrylic adhesive, ultraviolet-light-activated adhesive, polyurethane, polymer adhesives, and/or the like. In some examples, fastening the first chamfer to the second chamfer includes drilling through holes in the first chamfer and the second chamfer. In some examples, fastening the first chamfer to the second chamfer includes inserting fasteners into respective holes extending through the first chamfer and the second chamfer. In some examples, fastening the first chamfer to the second chamfer includes inserting fasteners into previously-manufactured holes formed during manufacture of the first composite fuselage member and the second composite fuselage member.

In some examples, method 800 is a method of assembling a circumferential skin joint as previously described, such as circumferential skin joint 10, 200, 300, 400, 500, and/or the like. Accordingly, in some examples step 804 of method 800 includes sliding the first tapered mating surface 26, 226, 326, 426, 526, against the second tapered mating surface 46, 246, 346, 446, 546 such that the first chamfer 22, 222, 322, 422, 522 is interior to the second chamfer 42, 242, 342, 442, 542. Similarly, in some examples, step 806 of method 800 includes fastening the first chamfer 22, 222, 322, 422, 522 to the second chamfer 42, 242, 342, 442, 542 to define the circumferential skin joint 10, 200, 300, 400, 500 between the first composite fuselage member 20, 220, 320, 420, 520 and the second composite fuselage member 40, 240, 340, 440, 540.

As schematically illustrated in dashed lines in FIG. 8, method 800 also may include a step 808 of fastening a stringer fitting to an interior surface of the first composite fuselage member and the second composite fuselage member. In some examples, the fastening the stringer fitting to the interior surface of the first composite fuselage member and the second composite fuselage member includes fastening the stringer fitting to the circumferential skin joint. In some examples, the fastening the stringer fitting to an interior surface of the first composite fuselage member and the second composite fuselage member includes fastening the stringer fitting directly to the first chamfer and indirectly to the second chamfer, such that fasteners extend through the first chamfer, the second chamfer, and the stringer fitting. In some examples, the fastening the stringer fitting to an interior surface of the first composite fuselage member and the second composite fuselage member includes inserting a filler between the stringer fitting and the second composite fuselage member. In some examples, the stringer fitting is substantially L-shaped, and the fastening the stringer fitting to the interior surface of the first composite fuselage member includes directly coupling the stringer fitting to the first composite skin and the second composite skin.

As also schematically illustrated in dashed lines in FIG. 8, method 800 also may include a step 802 of adjusting a slope of the first tapered mating surface and/or the second tapered mating surface. In some examples, the adjusting the slopes includes machining the first tapered mating surface and/or the second tapered mating surface. In some examples, step 802 may be completed before step 804. In some examples, adjusting the slope of the first tapered mating surface and/or the second tapered mating surface includes removing sacrificial material from the first composite skin of the first composite fuselage member or the second composite skin of the second composite fuselage member. In some examples, adjusting the slope of the first tapered mating surface and/or the second tapered mating surface includes utilizing precision machining methods, such as subtractive machining, cutting, milling, turning, and/or the like. In some examples, adjusting the slope of the first tapered mating surface and/or the second tapered mating surface includes utilizing Computer Numeric Control machining equipment.

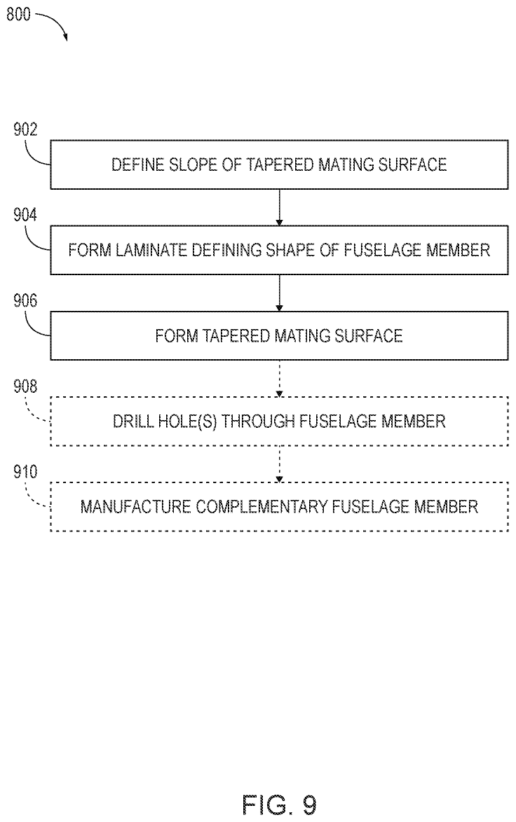

FIG. 9 schematically provides a flowchart that represents illustrative, non-exclusive examples of methods 900 according to the present disclosure. In FIG. 9, some steps are illustrated in dashed boxes indicating that such steps may be optional or may correspond to an optional version of a method according to the present disclosure. That said, not all methods according to the present disclosure are required to include the steps illustrated in solid boxes. The methods and steps illustrated in FIG. 9 are not limiting and other methods and steps are within the scope of the present disclosure, including methods having greater than or fewer than the number of steps illustrated, as understood from the discussions herein. Aspects of circumferential skin joints 10, 200, 300, 400, and 500 may be utilized in the method steps described below. Where appropriate, reference may be made to components and systems that may be used in carrying out each step. These references are for illustration and are not intended to limit the possible ways of carrying out any particular step of the method.

As seen in FIG. 9, a method 900 of manufacturing a first composite fuselage member includes a step 902 of selecting a slope of a first tapered mating surface of the first composite fuselage member; a step 904 of forming a first laminate defining an overall shape of a first composite skin of the first composite fuselage member; and a step 906 of forming the first tapered mating surface within the first laminate. In some examples, the first composite skin comprises a first chamfer that at least partially defines a first distal end of the first composite fuselage member, wherein the first chamfer defines the first tapered mating surface, such that the first tapered mating surface extends circumferentially around an outer surface of the first composite fuselage member. In some examples, the first tapered mating surface of the first composite fuselage member is configured to be coupled to a complementary second tapered mating surface of a second composite fuselage member to form a circumferential skin joint of a composite fuselage of an aerospace structure.

In some examples, the method 900 of manufacturing the first composite fuselage member includes manufacturing a first composite fuselage member 20, 220, 320, 420, 520 included in a circumferential skin joint 10, 200, 300, 400, 500. In these examples, the method 900 of manufacturing the first fuselage member 20, 220, 320, 420, 520 suitable for use in the circumferential skin joint 10, 200, 300, 400, 500 includes: selecting a slope of a first tapered mating surface 26, 226, 326, 426, 526 of the first composite fuselage member 20, 220, 320, 420, 520; forming a first laminate defining an overall shape of a first composite skin 28, 228, 328, 428, 528 of the first composite fuselage member 20, 220, 320, 420, 520; and forming the first tapered mating surface 26, 226, 326, 426, 526 within the first laminate.

As described above, step 902 of method 900 includes selecting a slope of a first tapered mating surface of the first composite fuselage member. Selecting the slope of the first tapered mating surface is performed such that forming the first tapered mating surface in step 906 produces a common mating surface (CMS) which is configured to mate with a complementary second tapered mating surface of the second composite fuselage member. In some examples, selecting the slope of the first tapered mating surface includes defining the first tapered mating surface in a computer-aided design program, such that models produced using the computer-aided design program may be utilized to provide molds, such as layup mandrels for use in manufacturing the first composite fuselage member. In some examples, layup mandrels in accordance to the present teachings are configured to form the first tapered mating surface when a laminate is manufactured using the layup mandrel. In some examples, layup mandrels in accordance with the present teachings are configured to form a laminate having sacrificial material, which is configured to be removed by machining when the first tapered mating surface is formed at step 906.

In some examples, selecting a slope of the first tapered mating surface further comprises manufacturing a layup mandrel, mold, or other tool for manufacturing a composite laminate. In some examples, selecting a slope of the first tapered mating surface includes calibrating machine tools such as lathes, mills, lasers, knives, and/or the like such that the slope may be machined from a laminate including sacrificial material.

Step 904 of method 900 includes forming a first laminate defining an overall shape of a first composite skin of the first composite fuselage member. Forming the first laminate may include any suitable method of forming a laminate comprising an aircraft composite material, but generally may include layering pre-impregnated fibrous sheets into a layup mandrel to form the first laminate. The fibrous sheets may comprise any suitable fibrous material, such as fiberglass, carbon fiber, polyaramid, and/or the like. The fibrous sheets may be pre-impregnated with any suitable curable polymer, such as epoxy resin, phenolic resin, thermoplastics, rubbers, resins, and/or the like. In some examples, fibers included in the fibrous sheets are woven. In some examples, fibers included in the fibrous sheets form nonwoven fabrics. In some examples, step 904 further comprises curing the first laminate, thereby forming the first composite fuselage member. Curing the first laminate may include any suitable method, such as vacuum-bag-only (VBO) curing, UV curing, autoclave curing, and/or the like. In some examples, step 904 further comprises removing (i.e., de-molding) the first composite fuselage member from the layup mandrel.

As described in more detail above with respect to circumferential skin joint 10, in some examples, the first laminate includes integrally laminated splice straps interleaved into the laminate. Accordingly, in some examples, a thickness of the first laminate varies along a longitudinal axis of the first laminate, as portions of the laminate including the integrally laminated splice straps (AKA reinforced portions) have an increased thickness when compared with portions of the laminate spaced apart from the circumferential skin joint. In other words, the first laminate includes a first region having more layers of material, defining a first reinforced portion, and a second region having fewer layers of material, defining a first composite skin. In some examples, the integrally laminated splice straps comprise pre-impregnated fibrous sheets. In some examples, the integrally laminated splice straps comprise pre-impregnated fibrous sheets comprising a same material as the pre-impregnated fibrous sheets forming the first composite skin. In some examples, the integrally laminated splice straps comprise pre-impregnated fibrous sheets comprising a different material from the pre-impregnated fibrous sheets forming the first composite skin.

Similarly, in some examples, the first laminate includes integrally laminated fail-safety straps, such as tear straps. In some examples, the tear straps are oriented along a longitudinal axis of the fuselage. In some examples, the tear straps comprise pre-impregnated fibrous sheets comprising a same material as the pre-impregnated fibrous sheets forming the first composite skin. In some examples, the tear straps comprise pre-impregnated fibrous sheets comprising a different material from the pre-impregnated fibrous sheets forming the first composite skin. Accordingly, in some examples, the tear straps include fibers oriented along a longitudinal axis of the first composite fuselage member.

In some examples, forming the first laminate includes compensating for future machining steps by including sacrificial material within the first laminate. The sacrificial material is configured to be removed by machining, such that the tapered mating surface may be machined to a high degree of precision at step 906. In some examples, the sacrificial material comprises a different material from the fibrous sheets forming the first laminate. In some examples, the sacrificial material comprises layers of fiberglass, while the fibrous sheets forming the laminate comprise carbon fiber. In some examples, the sacrificial material comprises a material having a different color from the fibrous sheets forming the first laminate, such that a transition between the sacrificial material and the fibrous sheets forming the first laminate is visible.

Step 906 of method 900 includes forming the first tapered mating surface within the laminate. In some examples, forming the first tapered mating surface includes machining the first composite skin of the first composite fuselage member. In some examples, machining the first composite skin of the first composite fuselage member includes removing sacrificial material from the first composite skin of the first composite fuselage member, wherein the sacrificial material is included within the first laminate. In some examples, machining the first composite skin to form the first tapered mating surface includes utilizing precision machining methods, such as subtractive machining, cutting, milling, turning, and/or the like. In some examples, machining the first composite skin to form the first tapered mating surface includes utilizing Computer Numeric Control machining equipment.

In some examples, step 904 and step 906 are performed substantially simultaneously. In such examples, tools, such as a layup mandrel tool utilized to form the first laminate, also are configured to form the first tapered mating surface. Accordingly, in some examples, forming the first tapered mating surface includes forming the first laminate within a mandrel tool configured to compensate for the first tapered mating surface.

In some examples, forming the first tapered mating surface is an iterative process, including machining the first tapered mating surface and/or forming the first tapered mating surface within a mandrel tool, scanning and/or measuring a slope of the first tapered mating surface, and adjusting the slope of the first tapered mating surface by machining.

As schematically illustrated in dashed lines in FIG. 9, method 900 of manufacturing the first composite fuselage member may include the step 908 of drilling one or more holes through the first fuselage member, wherein the one or more holes are configured to receive a fastener. In some examples, step 908 includes drilling the one or more holes while the first composite fuselage member is received within the layup mandrel.

As also schematically illustrated in dashed lines in FIG. 9, method 900 may also include the step 910 of manufacturing a complementary second composite fuselage member having a second tapered mating surface. In some examples, the second tapered mating surface is configured to be complementary to the first tapered mating surface, Accordingly, in some examples a slope of the second tapered mating surface is a reflection of the slope of the first tapered mating surface across a longitudinal axis of the circumferential skin joint. The second composite fuselage member may be manufactured using the same and/or similar steps as the first composite fuselage member, such as steps 902 through 908 of method 900.

Illustrative, non-exclusive examples of inventive subject matter according to the present disclosure are described in the following enumerated paragraphs:

A0. A circumferential skin joint (10) comprising:
a first composite fuselage member (20) having a first composite skin (28), the first composite skin (28) comprising a first chamfer (22) that at least partially defines a first distal end (24) of the first composite fuselage member (20), wherein the first chamfer (22) defines a first tapered mating surface (26) that extends circumferentially around an outer surface (23) of the first composite fuselage member (20); and
a second composite fuselage member (40) having a second composite skin (48), the second composite skin (48) comprising a second chamfer (42) that at least partially defines a second distal end (44) of the second composite fuselage member (40), wherein the second chamfer (42) defines a second tapered mating surface (46) that extends circumferentially around an inner surface (47) of the second composite fuselage member (40);
wherein the first tapered mating surface (26) contacts the second tapered mating surface (46) to form a tapered lap joint (60) between the first composite fuselage member (20) and the second composite fuselage member (40) and to at least partially define a composite fuselage of an aerospace structure.

A1. The circumferential skin joint (10) of paragraph A0, wherein, within the tapered lap joint (60), the first chamfer (22) is interior to the second chamfer (42).

A2. The circumferential skin joint (10) of paragraph A0 or paragraph A1, wherein the first composite skin (28) further comprises a first reinforced portion (30), and wherein a thickness of the first reinforced portion (30) is greater than a thickness of the first composite skin (28) in an area spaced apart from the circumferential skin joint (10).

A2.1. The circumferential skin joint (10) of paragraph A2, wherein the thickness of the first reinforced portion (30) is at least twice the thickness of the first composite skin (28).

A2.2. The circumferential skin joint (10) of paragraph A2 or paragraph A2.1, wherein the first reinforced portion (30) further comprises a ramped junction (32) between an outer surface of the first composite skin (28) and the first chamfer (22), wherein the ramped junction (32) comprises a decrease in an outer diameter of the first composite skin (28) having a slope different from a slope of the first tapered mating surface (26).

A2.2.1. The circumferential skin joint (10) of paragraph A2.2, wherein the ramped junction (32) has a height (33) substantially equivalent to a thickness (45) of the second distal end (44), such that the outer surface (23) of the first composite fuselage member (20) and an outer surface of the second composite fuselage member (40) are substantially flush.

A2.2.2. The circumferential skin joint (10) of paragraph A2.2, wherein the ramped junction (32) has a height (33) less than a thickness (45) of the second distal end (44), such that the outer surface (23) of the first composite fuselage member (20) is recessed relative to an outer surface (43) of the second composite fuselage member (40), and such that the second composite fuselage member (40) protects the outer surface (23) of the first composite fuselage member (20) from airstream erosion damage.

A2.2.2.1. The circumferential skin joint (10) of paragraph A2.2.2, further comprising an erosion protection foil covering the ramped junction (32).

A2.2.3. The circumferential skin joint (10) of paragraph A2.2, wherein the ramped junction (32) has a height (33) greater than a thickness (45) of the second distal end (44), such that the outer surface (23) of the first composite fuselage member (20) protects the second distal end (44) from airstream erosion damage.

A2.2.4. The circumferential skin joint (10) of any of paragraphs A2.2 through A2.2.3, wherein a recess (34) defined by the ramped junction (32) and the second distal end (44) is at least partially filled with sealant (36).

A2.2.5. The circumferential skin joint (10) of paragraph A2.2.4, wherein the sealant (36) comprises a polysulfide adhesive.

A2.2.6. The circumferential skin joint of any of paragraphs A2.2 through A2.2.5, wherein the ramped junction (32) has a slope of at least one of:
(i) at least 7:1, at least 8:1, at least 9:1, or at least 10:1; and
(ii) at most 14:1, at most 13:1, at most 12:1, at most 11:1, or at most 10:1.

A2.3. The circumferential skin joint (10) of any of paragraphs A2 through A2.2.5, wherein a maximum thickness of the first reinforced portion (30) is from 1.5× to 2.5×, from 1.75× to 2.15×, or from 1.9× to 2.1× a maximum thickness of the first chamfer (22), such that the tapered lap joint (60) substantially resembles a half lap joint with respect to the first composite fuselage member (20).

A3. The circumferential skin joint (10) of any of paragraphs A0 through A2.3, wherein the second composite skin (48) further comprises a second reinforced portion (50), and wherein a thickness of the second reinforced portion (50) is greater than a thickness of the second composite skin (48).

A3.1. The circumferential skin joint (10) of paragraph A3, wherein the thickness of the second reinforced portion (50) is at least 1.1× the thickness of the second composite skin (48).

A3.2. The circumferential skin joint (10) of paragraph A3 or paragraph A3.1, wherein the outer surface (23) of the first composite fuselage member (20) is recessed relative to an/the outer surface (43) of the second composite fuselage member (40) such that the second composite fuselage member (40) protects the outer surface (23) of the first composite fuselage member (20) from fluid damage.

A4 The circumferential skin joint (10) of any of paragraphs A0 through A3.2, wherein the first chamfer (22) comprises a decrease in an outer diameter of the first composite fuselage member (20) approaching the first distal end (24), and wherein the second chamfer (42) comprises an increase in an inner diameter of the second composite fuselage member (40) approaching the second distal end (44).

A5. The circumferential skin joint (10) of any of paragraphs A0 through A4, wherein the tapered lap joint (60) comprises a scarf joint.

A6 The circumferential skin joint (10) of any of paragraphs A0 through A5, wherein a/the maximum thickness of the first composite skin (28) is greater than a maximum thickness of the second composite skin (48).

A7 The circumferential skin joint (10) of any of paragraphs A0 through A6, wherein the first composite fuselage member (20) comprises a first layered composite material that includes a plurality of first layers of composite material; and
wherein the second composite fuselage member (40) comprises a second layered composite material that includes a plurality of second layers of composite material.

A7.1. The circumferential skin joint (10) of paragraph A7, further comprising a plurality of first tear straps (38) integrally laminated within the plurality of first layers of composite material, wherein the plurality of first tear straps (38) is oriented along a longitudinal axis of the composite fuselage (100).

A7.1.1. The circumferential skin joint (10) of paragraph A7.1, wherein the plurality of first tear straps (38) comprises fibers, and wherein the fibers of the plurality of first tear straps (38) are oriented along a/the longitudinal axis of the first composite fuselage member (20).

A7.1.2. The circumferential skin joint (10) of paragraph A7.1 or paragraph A7.1.1, wherein the plurality of first tear straps (38) has a length of at least one of:
(i) at least equal to, at least twice, at least three times, at least four times, or at least five times a width of the tapered lap joint (60); and
(ii) at most eight times, at most seven times, at most six times, or at least five times the width of the tapered lap joint (60).

A7.1.3. The circumferential skin joint (10) of any of paragraphs A7 through paragraph A7.1.2, further comprising a plurality of second tear straps (58) integrally laminated within the plurality of second layers of composite material, wherein the plurality of second tear straps (58) is oriented along a/the longitudinal axis of the composite fuselage (100).

A7.1.4. The circumferential skin joint (10) of paragraph A7.1.3, wherein the plurality of second tear straps (58) comprises fibers, and wherein the fibers of the plurality of second tear straps (58) are oriented along a/the longitudinal axis of the second composite fuselage member (40).

A7.1.5. The circumferential skin joint (10) of paragraph A7.1.3 or paragraph A7.1.4, wherein the plurality of second tear straps (58) has a length of at least one of:
(i) at least equal to, at least twice, at least three times, or least four times a/the width of the tapered lap joint (60); and
(ii) at most eight times, at most seven times, or at most six times the width of the tapered lap joint (60).

A7.2. The circumferential skin joint (10) of any of paragraphs A7 through A7.1.5, wherein the first composite fuselage member (20) and the second composite fuselage member (40) each comprise a respective reinforced portion (30, 50) including integrally laminated splice straps providing an increased thickness of the first composite fuselage member (20) and the second composite fuselage member (40) at the tapered lap joint (60).

A8. The circumferential skin joint (10) of any of paragraphs A0 through A7.2, further comprising at least two fasteners (70) extending through the first chamfer (22) and the second chamfer (42), such that the at least two fasteners (70) couple the first composite fuselage member (20) to the second composite fuselage member (40).

A8.1. The circumferential skin joint (10) of paragraph A8, wherein the at least two fasteners (70) comprise bolts, nuts, rivets, or pins.

A8.2. The circumferential skin joint (10) of paragraph A8 or A8.1, wherein the at least two fasteners (70) are evenly distributed around a circumference of the fuselage (100).

A9. The circumferential skin joint (10) of any of paragraphs A8 through A8.2, further comprising a stringer fitting (80), wherein the stringer fitting (80) is coupled to the first composite fuselage member (20) by a first fastener (70) of the at least two fasteners (70) and coupled to the second composite fuselage member (40) by a second fastener (70) of the at least two fasteners (70).

A9.1. The circumferential skin joint (10) of paragraph A9, wherein the first fastener (70) extends through both the first chamfer (22) and the second chamfer (42), and wherein the second fastener (70) extends through both the first chamfer (22) and the second chamfer (42).

A9.2. The circumferential skin joint (10) of paragraph A9, wherein the first fastener (70) is coupled to a/the first reinforced portion (30), and wherein the second fastener (70) is coupled to a/the second reinforced portion (50).

A9.3. The circumferential skin joint (10) of any of paragraphs A9 through A9.2, wherein the stringer fitting (80) is directly coupled to the second composite fuselage member (40).

A9.4 The circumferential skin joint (10) of paragraph A9.3, wherein the stringer fitting (80) has an L-shaped cross-section.

A9.5. The circumferential skin joint (10) of any of paragraphs A9 through A9.2, further comprising a filler (82) disposed between the stringer fitting (80) and the second composite fuselage member (40).

A9.6. The circumferential skin joint (10) of paragraph A9.5, wherein the filler (82) comprises a co-cured composite material.

A10. The circumferential skin joint (10) of any of paragraphs A0 through A9.6, wherein the first tapered mating surface (26) and the second tapered mating surface (46) each have a slope of at least one of:
(i) at least 5:1, at least 8:1, at least 9:1, or at least 10:1; and
(ii) at most 20:1, at most 15:1, at most 12:1, or at most 10:1.

A11. The circumferential skin joint (10) of any of paragraphs A0 through A10, wherein the first composite fuselage member (20) and the second composite fuselage member (40) are at least partially cylindrical, at least substantially cylindrical, or cylindrical.

A12. The circumferential skin joint (10) of any of paragraphs A0 through A11, wherein the first composite fuselage member (20) and the second composite fuselage member (40) are substantially semi-cylindrical.

A13. The circumferential skin joint (10) of any of paragraphs A0 through A12, wherein the first tapered mating surface (26) is bonded to the second tapered mating surface (46).

B0. A fuselage (100) comprising any suitable structure, function, and/or feature, or combination of structures, functions, and/or features, recited in any of paragraphs A0 through A13.

B1. The fuselage (100) of paragraph B0, wherein the second composite fuselage member (40) is disposed forward of the first composite fuselage member (20). B2. The fuselage (100) of paragraph B0, wherein the first composite fuselage member (20) is disposed forward of the second composite fuselage member (40).

B3. The fuselage (100) of any of paragraphs B0 through B2, wherein the fuselage (100) comprises a fuselage of an aerospace structure.

B3.1. The fuselage (100) of paragraph B3, wherein the fuselage (100) comprises a fuselage of an aircraft.

B3.2. The fuselage (100) of paragraph B3, wherein the fuselage (100) comprises a fuselage of a spacecraft.

B3.2.1. The fuselage (100) of paragraph B3.2, wherein the spacecraft comprises a rocket.

C0. A method of assembly (800) of any suitable structure, function, and/or feature, or combination of structures, functions, and/or features, recited in any of paragraphs A0 through A13, the method (800) comprising:
sliding (804) the first tapered mating surface against the second tapered mating surface such that the first chamfer is interior to the second chamfer; and
fastening (806) the first chamfer to the second chamfer to define the circumferential skin joint between the first composite fuselage member and the second composite fuselage member.

C1. A method of assembly (800) of a circumferential skin joint, the method (800) comprising:
sliding (804) a first tapered mating surface of a first composite fuselage member having a first composite skin against a second tapered mating surface of a second composite fuselage member having a second composite skin;
wherein the first composite skin comprises a first chamfer that at least partially defines a first distal end of the first composite fuselage member, wherein the first chamfer defines the first tapered mating surface that extends circumferentially around an outer surface of the first composite fuselage member; and
wherein the second composite skin comprises a second chamfer that at least partially defines a second distal end of the second composite fuselage member, wherein the second chamfer defines the second tapered mating surface that extends circumferentially around an inner surface of the second composite fuselage member, and further wherein the sliding (804) the first tapered mating surface against the second tapered mating surface includes sliding the first tapered mating surface against the second tapered mating surface such that the first chamfer is interior to the second chamfer; and
fastening (806) the first chamfer to the second chamfer to define the circumferential skin joint between the first composite fuselage member and the second composite fuselage member and to at least partially define a composite fuselage of an aerospace structure.

C2. The method of assembly (800) of paragraph C0 or paragraph C1, wherein the fastening (806) the first chamfer to the second chamfer includes bolting the first chamfer to the second chamfer.

C3. The method of assembly (800) of any of paragraphs C0 through C2, wherein the fastening (806) the first chamfer to the second chamfer includes bonding the first chamfer to the second chamfer with adhesive.

C3.1. The method of assembly (800) of any of paragraphs C0 through C2, wherein the fastening (806) the first chamfer to the second chamfer includes bonding the first chamfer to the second chamfer using thermoplastic welding.

C4. The method of assembly (800) of any of paragraphs C0 through C3, wherein the sliding (804) the first tapered mating surface against the second tapered mating surface includes adjusting a length of a fuselage that includes the first composite fuselage member and the second composite fuselage member.

C5. The method of assembly (800) of any of paragraphs C0 through C4, further comprising fastening (808) a stringer fitting to an interior surface of the first composite fuselage member and the second composite fuselage member.

C5.1. The method of assembly (800) of paragraph C5, wherein the fastening (808) the stringer fitting to the interior surface of the first composite fuselage member and the second composite fuselage member includes fastening the stringer fitting to the circumferential skin joint.

C5.2. The method of assembly (800) of paragraph C5 or paragraph C5.1, wherein the fastening (808) the stringer fitting to the interior surface of the first composite fuselage member and the second composite fuselage member includes inserting a filler between the stringer fitting and the second composite fuselage member.

C5.3. The method of assembly (800) of paragraph C5 or paragraph C5.1, wherein the stringer fitting is substantially L-shaped, and wherein the fastening (808) the stringer fitting to the interior surface of the first composite fuselage member includes directly coupling the stringer fitting to the first composite skin and the second composite skin.

C6. The method of assembly (800) of any of paragraphs C0 through C5.3, further comprising adjusting (802) a slope of the first tapered mating surface and/or the second tapered mating surface by machining the first tapered mating surface and/or the second tapered mating surface.

C7. The method of assembly (800) of any of paragraphs C0 through C6, wherein the first composite fuselage member and the second composite fuselage member are substantially cylindrical, and wherein the sliding (804) the first tapered mating surface against the second tapered mating surface causes the first chamfer to be received at least partially within the second composite fuselage member.

D0. A method of manufacturing (900) a first fuselage member suitable for use in the circumferential skin joint of any of paragraphs A0 through A13, the method (900) comprising:
selecting (902) a slope of the first tapered mating surface of the first composite fuselage member;
forming (906) a first laminate defining an overall shape of the first composite skin of the first composite fuselage member; and
forming (906) the first tapered mating surface within the first laminate.

D1. A method of manufacturing (900) a first composite fuselage member, the method comprising:
selecting (904) a slope of a first tapered mating surface of the first composite fuselage member;
forming (906) a first laminate defining an overall shape of a first composite skin of the first composite fuselage member; and
forming (908) the first tapered mating surface within the first laminate;
wherein the first composite skin comprises a first chamfer that at least partially defines a first distal end of the first composite fuselage member, wherein the first chamfer defines the first tapered mating surface, such that the first tapered mating surface extends circumferentially around an outer surface of the first composite fuselage member; and
wherein the first tapered mating surface of the first composite fuselage member is configured to be coupled to a complementary second tapered mating surface of a second composite fuselage member to form a circumferential skin joint of a composite fuselage of an aerospace structure.

D2. The method of manufacturing (900) of paragraph DO or paragraph D1, further comprising infusing resin into the first laminate.

D3. The method of manufacturing (900) of any of paragraphs DO through D2, further comprising curing the first laminate, thereby forming the first composite fuselage member.

D4. The method of manufacturing (900) of any of paragraphs DO through D3, wherein the forming (906) the first tapered mating surface includes forming the first laminate within a mandrel tool configured to compensate for the first tapered mating surface.

D5. The method of manufacturing (900) of any of paragraphs DO through D4, wherein the forming (906) the first tapered mating surface includes machining the first composite skin of the first composite fuselage member.

D5.1. The method of manufacturing (900) of paragraph D5, wherein the machining the first composite skin of the first composite fuselage member includes removing sacrificial material from the first composite skin of the first composite fuselage member, wherein the sacrificial material is included within the first laminate.

D6. The method of manufacturing (900) of any of paragraphs DO through D5.1, wherein the first laminate comprises a first region having more layers of material and a second region having fewer layers of material.

D6.1. The method of manufacturing (900) of paragraph D6, wherein the first region defines a first reinforced portion, and wherein the second region defines the first composite skin.

D6.2. The method of manufacturing (900) of paragraphs D6 or D6.1, wherein the first region includes a first plurality of tear straps integrally laminated within the first laminate, wherein the tear straps are oriented along a longitudinal axis of the first composite fuselage member.

D7. The method of manufacturing (900) of any of paragraphs DO through D6.3, further comprising drilling (908) one or more holes through the first fuselage member, wherein the one or more holes are configured to receive a fastener.

D8. The method of manufacturing (900) of any of paragraphs DO through D7, further comprising manufacturing (910) a/the complementary second composite fuselage member having a/the second tapered mating surface, wherein a slope of the second tapered mating surface is a reflection of the slope of the first tapered mating surface across a longitudinal axis of the circumferential skin joint.

E0. The use of a circumferential skin joint 10 according to any of paragraphs A0 through A13.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

As used herein, the term “and/or” placed between a first entity and a second entity means one of (1) the first entity, (2) the second entity, and (3) the first entity and the second entity. Multiple entries listed with “and/or” should be construed in the same manner, i.e., “one or more” of the entities so conjoined. Other entities optionally may be present other than the entities specifically identified by the “and/or” clause, whether related or unrelated to those entities specifically identified. Thus, as a non-limiting example, a reference to “A and/or B,” when used in conjunction with open-ended language such as “comprising,” may refer, in one example, to A only (optionally including entities other than B); in another example, to B only (optionally including entities other than A); in yet another example, to both A and B (optionally including other entities). These entities may refer to elements, actions, structures, steps, operations, values, and the like.

The various disclosed elements of apparatuses and steps of methods disclosed herein are not required to all apparatuses and methods according to the present disclosure, and the present disclosure includes all novel and non-obvious combinations and subcombinations of the various elements and steps disclosed herein. Moreover, one or more of the various elements and steps disclosed herein may define independent inventive subject matter that is separate and apart from the whole of a disclosed apparatus or method. Accordingly, such inventive subject matter is not required to be associated with the specific apparatuses and methods that are expressly disclosed herein, and such inventive subject matter may find utility in apparatuses and/or methods that are not expressly disclosed herein.

1. A circumferential skin joint comprising:
a first composite fuselage member having a first composite skin, the first composite skin comprising a first chamfer that at least partially defines a first distal end of the first composite fuselage member, wherein the first chamfer defines a first tapered mating surface that extends circumferentially around an outer surface of the first composite fuselage member; and
a second composite fuselage member having a second composite skin, the second composite skin comprising a second chamfer that at least partially defines a second distal end of the second composite fuselage member, wherein the second chamfer defines a second tapered mating surface that extends circumferentially around an inner surface of the second composite fuselage member;
wherein the first tapered mating surface contacts the second tapered mating surface to form a tapered lap joint between the first composite fuselage member and the second composite fuselage member and to at least partially define a composite fuselage of an aerospace structure.

2. The circumferential skin joint of claim 1, wherein, within the tapered lap joint, the first chamfer is interior to the second chamfer.

3. The circumferential skin joint of claim 1, wherein the first composite skin further comprises a first reinforced portion, and wherein a thickness of the first reinforced portion is greater than a thickness of the first composite skin in an area spaced apart from the circumferential skin joint.

4. The circumferential skin joint of claim 3, wherein the first reinforced portion further comprises a ramped junction between an outer surface of the first composite skin and the first chamfer, wherein the ramped junction comprises a decrease in an outer diameter of the first composite skin having a slope different from a slope of the first tapered mating surface.

5. The circumferential skin joint of claim 4, wherein the ramped junction has a height less than a thickness of the second distal end, such that the outer surface of the first composite fuselage member is recessed relative to an outer surface of the second composite fuselage member, and such that the second composite fuselage member protects the outer surface of the first composite fuselage member from airstream erosion damage.

6. The circumferential skin joint of claim 4, wherein a recess defined by the ramped junction and the second distal end is at least partially filled with sealant.

7. The circumferential skin joint of claim 3, wherein the second composite skin further comprises a second reinforced portion, and wherein a thickness of the second reinforced portion is greater than a thickness of the second composite skin.

8. The circumferential skin joint of claim 1, wherein the first chamfer comprises a decrease in an outer diameter of the first composite fuselage member approaching the first distal end, and wherein the second chamfer comprises an increase in an inner diameter of the second composite fuselage member approaching the second distal end.

9. The circumferential skin joint of claim 1, wherein the first composite fuselage member comprises a first layered composite material that includes a plurality of first layers of composite material; and
wherein the second composite fuselage member comprises a second layered composite material that includes a plurality of second layers of composite material.

10. The circumferential skin joint of claim 9, further comprising a plurality of first tear straps integrally laminated within the plurality of first layers of composite material, wherein the plurality of first tear straps comprises fibers, and wherein the fibers of the plurality of first tear straps are oriented along a longitudinal axis of the first composite fuselage member.

11. The circumferential skin joint of claim 10, wherein the plurality of first tear straps has a length at least equal to a width of the tapered lap joint and at most eight times the width of the tapered lap joint.

12. The circumferential skin joint of claim 1, further comprising at least two fasteners extending through the first chamfer and the second chamfer, such that the at least two fasteners couple the first composite fuselage member to the second composite fuselage member.

13. The circumferential skin joint of claim 12, further comprising a stringer fitting, wherein the stringer fitting is coupled to the first composite fuselage member by a first fastener of the at least two fasteners and coupled to the second composite fuselage member by a second fastener of the at least two fasteners.

14. The circumferential skin joint of claim 1, wherein the first tapered mating surface and the second tapered mating surface each have a slope of at least 5:1 and at most 20:1.

15. A method of assembly of a circumferential skin joint, the method comprising:
sliding a first tapered mating surface of a first composite fuselage member having a first composite skin against a second tapered mating surface of a second composite fuselage member having a second composite skin, wherein the first composite skin comprises a first chamfer that at least partially defines a first distal end of the first composite fuselage member, wherein the first chamfer defines the first tapered mating surface that extends circumferentially around an outer surface of the first composite fuselage member, wherein the second composite skin comprises a second chamfer that at least partially defines a second distal end of the second composite fuselage member, wherein the second chamfer defines the second tapered mating surface that extends circumferentially around an inner surface of the second composite fuselage member, and further wherein the sliding the first tapered mating surface against the second tapered mating surface includes sliding the first tapered mating surface against the second tapered mating surface such that the first chamfer is interior to the second chamfer; and
fastening the first chamfer to the second chamfer to define the circumferential skin joint between the first composite fuselage member and the second composite fuselage member and to at least partially define a composite fuselage of an aerospace structure.

16. The method of assembly of claim 15, wherein the sliding the first tapered mating surface against the second tapered mating surface includes adjusting a length of a fuselage that includes the first composite fuselage member and the second composite fuselage member.

17. The method of assembly of claim 15, wherein the first composite fuselage member and the second composite fuselage member are substantially cylindrical, and wherein the sliding the first tapered mating surface against the second tapered mating surface causes the first chamfer to be received at least partially within the second composite fuselage member.

18. A method of manufacturing a first composite fuselage member, the method comprising:
selecting a slope of a first tapered mating surface of the first composite fuselage member;
forming a first laminate defining an overall shape of a first composite skin of the first composite fuselage member; and
forming the first tapered mating surface within the first laminate;
wherein the first composite skin comprises a first chamfer that at least partially defines a first distal end of the first composite fuselage member;
wherein the first chamfer defines the first tapered mating surface, such that the first tapered mating surface extends circumferentially around an outer surface of the first composite fuselage member; and
wherein the first tapered mating surface of the first composite fuselage member is configured to be coupled to a complementary second tapered mating surface of a second composite fuselage member to form a circumferential skin joint of a composite fuselage of an aerospace structure.

19. The method of manufacturing of claim 18, wherein the forming the first tapered mating surface includes forming the first laminate within a mandrel tool configured to compensate for the first tapered mating surface.

20. The method of manufacturing of claim 18, wherein the forming the first tapered mating surface includes machining the first composite skin of the first composite fuselage member.
